(19) United States
(12) Patent Application Publication
(10) Pub. No.: US 2023/0319728 A1
(43) Pub. Date: Oct. 5, 2023

(54) TECHNIQUES FOR INDICATING UPLINK POWER LIMIT FOR FULL-DUPLEX COMMUNICATIONS

(71) Applicant: QUALCOMM Incorporated, San Diego, CA (US)

(72) Inventors: Yan Zhou, San Diego, CA (US); Qian Zhang, Basking Ridge, NJ (US); Navid Abedini, Basking Ridge, NJ (US); Tao Luo, San Diego, CA (US)

(21) Appl. No.: 17/711,912

(22) Filed: Apr. 1, 2022

(51) Int. Cl. H04W 52/14; H04W 24/10; H04L 5/14; H04W 52/24; H04W 52/36

(52) U.S. Cl. CPC H04W 52/146; H04W 24/10; H04L 5/14; H04W 52/243; H04W 52/367

(57) ABSTRACT

Methods, systems, and devices for wireless communications are described. A network entity may receive, from a first user equipment (UE) (e.g., victim UE), a first uplink message including a cross-link interference (CLI) report associated with CLI experienced at the first UE and a set of CLI parameters associated with the first UE. The network entity may transmit, to a second UE (e.g., aggressor UE) based on the first uplink message, a first downlink message indicating an uplink power limit associated with uplink communications transmitted by the second UE during a full-duplex operational mode at the network entity. The network entity may then communicate with the first and second UEs in accordance with the full-duplex operational mode and based on the uplink power limit.

### TECHNICAL FIELD

The following relates to wireless communications, including techniques for indicating uplink power limits for full-duplex communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, UEs may be configured to measure cross-link interference (CLI) attributable to signals received from other UEs. For example, a “victim” UE may experience CLI from signals transmitted by an “aggressor” UE in cases where uplink communications transmitted by the aggressor UE collide with downlink communications received by the victim UE. Left unaddressed, CLI may lead to increased noise, and reduce an efficiency and reliability of wireless communications.

### SUMMARY

The described techniques relate to improved methods, systems, devices, and apparatuses that support techniques for indicating an uplink power limit for full-duplex communications. In particular, the described techniques provide for signaling and techniques which enable network entities to control a transmission power of aggressor user equipments (UEs) in order to mitigate cross-link interference (CLI) experienced at victim UEs during full-duplex operational modes at the network entities. For example, a victim UE may transmit a CLI report to a network entity indicating CLI experienced by the victim UE during an full-duplex operational mode at the network entity. The CLI report may also indicate CLI parameters of the victim UE, such as a CLI limit/range, a CLI reduction value, etc. The network entity may calculate an uplink power limit for the aggressor UE to use during the full-duplex operational mode at the network entity based on the received CLI report and CLI parameters, and may indicate the uplink power limit to the aggressor UE, where the uplink power limit is configured to reduce or eliminate CLI at the victim UE. Subsequently, the network entity can receive uplink messages from the aggressor UE in accordance with the uplink power limit, and simultaneously transmit downlink messages to the victim UE during the full-duplex operational mode at the network entity.

A method for wireless communication at a network entity is described. The method may include receiving, from a first UE a first uplink message indicating a CLI report associated with CLI experienced at the first UE and a set of CLI parameters associated with the first UE, transmitting, to a second UE based on the first uplink message, a first downlink message indicating an uplink power limit associated with uplink communications transmitted by the second UE during a full-duplex operational mode at the network entity, transmitting a second downlink message to the first UE during a transmission time interval (TTI) in accordance with the full-duplex operational mode and based on transmitting the first downlink message, and receiving, from the second UE during the TTI, a second uplink message in accordance with the uplink power limit and the full-duplex operational mode.

An apparatus for wireless communication at a network entity is described. The apparatus may include at least one processor, memory coupled to the at least one processor, and instructions stored in the memory. The instructions may be executable by the at least one processor to cause the network entity to receive, from a first UE a first uplink message indicating a CLI report associated with CLI experienced at the first UE and a set of CLI parameters associated with the first UE, transmit, to a second UE based on the first uplink message, a first downlink message indicating an uplink power limit associated with uplink communications transmitted by the second UE during a full-duplex operational mode at the network entity, transmit a second downlink message to the first UE during a TTI in accordance with the full-duplex operational mode and based on transmitting the first downlink message, and receive, from the second UE during the TTI, a second uplink message in accordance with the uplink power limit and the full-duplex operational mode.

Another apparatus for wireless communication at a network entity is described. The apparatus may include means for receiving, from a first UE a first uplink message indicating a CLI report associated with CLI experienced at the first UE and a set of CLI parameters associated with the first UE, means for transmitting, to a second UE based on the first uplink message, a first downlink message indicating an uplink power limit associated with uplink communications transmitted by the second UE during a full-duplex operational mode at the network entity, means for transmitting a second downlink message to the first UE during a TTI in accordance with the full-duplex operational mode and based on transmitting the first downlink message, and means for receiving, from the second UE during the TTI, a second uplink message in accordance with the uplink power limit and the full-duplex operational mode.

A non-transitory computer-readable medium storing code for wireless communication at a network entity is described. The code may include instructions executable by at least one processor to receive, from a first UE a first uplink message indicating a CLI report associated with CLI experienced at the first UE and a set of CLI parameters associated with the first UE, transmit, to a second UE based on the first uplink message, a first downlink message indicating an uplink power limit associated with uplink communications transmitted by the second UE during a full-duplex operational mode at the network entity, transmit a second downlink message to the first UE during a TTI in accordance with the full-duplex operational mode and based on transmitting the first downlink message, and receive, from the second UE during the TTI, a second uplink message in accordance with the uplink power limit and the full-duplex operational mode.

Some examples of the method, apparatuses, and non-transitory computer-readable medium described herein may further include operations, features, means, or instructions for receiving, via the CLI report of the first uplink message, an indication of a CLI limit, a CLI range, or both, where the set of CLI parameters includes the CLI limit, the CLI range, or both and selecting the uplink power limit associated with the full-duplex operational mode based on the CLI limit, the CLI range, or both, where transmitting the first downlink message may be based on the selecting.

In some examples of the method, apparatuses, and non-transitory computer-readable medium described herein, the uplink power limit may be selected such that CLI experienced at the first UE that may be attributable to uplink communications transmitted by the second UE during the full-duplex operational mode may be less than or equal to the CLI limit, an upper bound of the CLI range, or both.

In some examples of the method, apparatuses, and non-transitory computer-readable medium described herein, the set of CLI parameters may be associated with the full-duplex operational mode at the network entity and the method, apparatuses, and non-transitory computer-readable medium may include further operations, features, means, or instructions for receiving, via the first uplink message, an additional uplink message, or both, an additional set of CLI parameters associated with the first UE and a half-duplex operational mode at the network entity and transmitting, to the second UE based on the additional set of CLI parameters, an additional uplink power limit associated with uplink communications transmitted by the second UE during the half-duplex operational mode.

In some examples of the method, apparatuses, and non-transitory computer-readable medium described herein, the set of CLI parameters may be associated with a first set of resources usable during the full-duplex operational mode and the method, apparatuses, and non-transitory computer-readable medium may include further operations, features, means, or instructions for receiving, via the first uplink message, an additional uplink message, or both, an additional set of CLI parameters associated with a second set of resources usable during the full-duplex operational mode at the network entity, where the uplink power limit may be based on the set of CLI parameters, the additional set of CLI parameters, or both.

Some examples of the method, apparatuses, and non-transitory computer-readable medium described herein may further include operations, features, means, or instructions for receiving, via the first uplink message, a request for reduced CLI at the first UE during a time duration and transmitting, via the first downlink message, an indication of the time duration associated with the uplink power limit, where the TTI may be included within the time duration.

Some examples of the method, apparatuses, and non-transitory computer-readable medium described herein may further include operations, features, means, or instructions for receiving, from the second UE, a second uplink message indicating available uplink power information associated with uplink communications transmitted by the second UE during the full-duplex operational mode, where the uplink power limit may be based on the available uplink power information.

Some examples of the method, apparatuses, and non-transitory computer-readable medium described herein may further include operations, features, means, or instructions for receiving, via the second uplink message, an indication of one or more parameters associated with the available uplink power information, the one or more parameters including a transmit beam at the second UE, a sub-band, a symbol, a resource pattern, or any combination thereof, where the uplink power limit may be based on the one or more parameters.

In some examples of the method, apparatuses, and non-transitory computer-readable medium described herein, the uplink power limit includes an indication of a power spectral density (PSD), a power backoff value, a maximum absolute power value, or any combination thereof.

In some examples of the method, apparatuses, and non-transitory computer-readable medium described herein, the CLI report includes one or more CLI measurements performed by the first UE on signals received from the second UE during the full-duplex operational mode and the uplink power limit may be based on the one or more CLI measurements.

In some examples of the method, apparatuses, and non-transitory computer-readable medium described herein, the set of CLI parameters associated with the first UE include a CLI reduction value and the uplink power limit may be based on the CLI reduction value.

In some examples of the method, apparatuses, and non-transitory computer-readable medium described herein, the first uplink message includes an indication of the second UE and transmitting the first downlink message to the second UE may be based on the indication of the second UE.

In some examples of the method, apparatuses, and non-transitory computer-readable medium described herein, the first uplink message includes an uplink control information (UCI) message, a medium access control-control element (MAC-CE) message, or both.

A method for wireless communication at a UE is described. The method may include transmitting a first uplink message to a network entity during a full-duplex operational mode at the network entity, receiving, from the network entity based on the first uplink message, a downlink message indicating an uplink power limit associated with uplink communications transmitted by the UE during the full-duplex operational mode at the network entity, adjusting a transmission power used for transmitting uplink messages during the full-duplex operational mode based on the uplink power limit, and transmitting a second uplink message to the network entity in accordance with the uplink power limit and the full-duplex operational mode at the network entity.

An apparatus for wireless communication at a UE is described. The apparatus may include at least one processor, memory coupled to the at least one processor, and instructions stored in the memory. The instructions may be executable by the at least one processor to cause the UE to transmit a first uplink message to a network entity during a full-duplex operational mode at the network entity, receive, from the network entity based on the first uplink message, a downlink message indicating an uplink power limit associated with uplink communications transmitted by the UE during the full-duplex operational mode at the network entity, adjust a transmission power used for transmitting uplink messages during the full-duplex operational mode based on the uplink power limit, and transmit a second uplink message to the network entity in accordance with the uplink power limit and the full-duplex operational mode at the network entity.

Another apparatus for wireless communication at a UE is described. The apparatus may include means for transmitting a first uplink message to a network entity during a full-duplex operational mode at the network entity, means for receiving, from the network entity based on the first uplink message, a downlink message indicating an uplink power limit associated with uplink communications transmitted by the UE during the full-duplex operational mode at the network entity, means for adjusting a transmission power used for transmitting uplink messages during the full-duplex operational mode based on the uplink power limit, and means for transmitting a second uplink message to the network entity in accordance with the uplink power limit and the full-duplex operational mode at the network entity.

A non-transitory computer-readable medium storing code for wireless communication at a UE is described. The code may include instructions executable by at least one processor to transmit a first uplink message to a network entity during a full-duplex operational mode at the network entity, receive, from the network entity based on the first uplink message, a downlink message indicating an uplink power limit associated with uplink communications transmitted by the UE during the full-duplex operational mode at the network entity, adjust a transmission power used for transmitting uplink messages during the full-duplex operational mode based on the uplink power limit, and transmit a second uplink message to the network entity in accordance with the uplink power limit and the full-duplex operational mode at the network entity.

Some examples of the method, apparatuses, and non-transitory computer-readable medium described herein may further include operations, features, means, or instructions for transmitting, to the network entity via the first uplink message, an additional uplink message, or both, an indication of available uplink power information associated with uplink communications transmitted by the UE during the full-duplex operational mode, where the uplink power limit may be based on the available uplink power information.

Some examples of the method, apparatuses, and non-transitory computer-readable medium described herein may further include operations, features, means, or instructions for transmitting, via the first uplink message, the additional uplink message, or both, an indication of one or more parameters associated with the available uplink power information, the one or more parameters including a transmit beam at the UE, a sub-band, a symbol, a resource pattern, or any combination thereof, where the uplink power limit may be based on the one or more parameters.

Some examples of the method, apparatuses, and non-transitory computer-readable medium described herein may further include operations, features, means, or instructions for receiving, via the downlink message, an additional downlink message, or both, an additional uplink power limit associated with uplink communications transmitted by the UE during a half-duplex operational mode of the network entity and transmitting a third uplink message to the network entity in accordance with the additional uplink power limit and the half-duplex operational mode at the network entity.

Some examples of the method, apparatuses, and non-transitory computer-readable medium described herein may further include operations, features, means, or instructions for receiving, via the downlink message, an indication of a time duration associated with the uplink power limit, where adjusting the transmission power, transmitting the second uplink message, or both, may be based on the time duration.

In some examples of the method, apparatuses, and non-transitory computer-readable medium described herein, the uplink power limit includes an indication of a PSD, a power backoff value, a maximum absolute power value, or any combination thereof.

A method for wireless communication at a first UE is described. The method may include performing one or more CLI measurements associated with uplink communications transmitted by a second UE to a network entity during a full-duplex operational mode at the network entity, transmitting, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode, and receiving a downlink message from the network entity during the full-duplex operational mode and based on the uplink message.

An apparatus for wireless communication at a first UE is described. The apparatus may include at least one processor, memory coupled to the at least one processor, and instructions stored in the memory. The instructions may be executable by the at least one processor to cause the first UE to perform one or more CLI measurements associated with uplink communications transmitted by a second UE to a network entity during a full-duplex operational mode at the network entity, transmit, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode, and receive a downlink message from the network entity during the full-duplex operational mode and based on the uplink message.

Another apparatus for wireless communication at a first UE is described. The apparatus may include means for performing one or more CLI measurements associated with uplink communications transmitted by a second UE to a network entity during a full-duplex operational mode at the network entity, means for transmitting, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode, and means for receiving a downlink message from the network entity during the full-duplex operational mode and based on the uplink message.

A non-transitory computer-readable medium storing code for wireless communication at a first UE is described. The code may include instructions executable by at least one processor to perform one or more CLI measurements associated with uplink communications transmitted by a second UE to a network entity during a full-duplex operational mode at the network entity, transmit, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode, and receive a downlink message from the network entity during the full-duplex operational mode and based on the uplink message.

Some examples of the method, apparatuses, and non-transitory computer-readable medium described herein may further include operations, features, means, or instructions for transmitting, via the uplink message, an indication of a CLI limit, a CLI range, or both, where the set of CLI parameters include the CLI limit, the CLI range, or both.

In some examples of the method, apparatuses, and non-transitory computer-readable medium described herein, the set of CLI parameters may be associated with the full-duplex operational mode at the network entity and the method, apparatuses, and non-transitory computer-readable medium may include further operations, features, means, or instructions for transmitting, via the uplink message, an additional uplink message, or both, an additional set of CLI parameters associated with the first UE and a half-duplex operational mode at the network entity and receiving an additional downlink message from the network entity during the half-duplex operational mode and based on the additional set of CLI parameters.

In some examples of the method, apparatuses, and non-transitory computer-readable medium described herein, the set of CLI parameters may be associated with a first set of resources usable during the full-duplex operational mode and the method, apparatuses, and non-transitory computer-readable medium may include further operations, features, means, or instructions for transmitting, via the uplink message, an additional uplink message, or both, an additional set of CLI parameters associated with a second set of resources usable during the full-duplex operational mode at the network entity, where the downlink message may be based on the set of CLI parameters, the additional set of CLI parameters, or both.

Some examples of the method, apparatuses, and non-transitory computer-readable medium described herein may further include operations, features, means, or instructions for transmitting, via the uplink message, a request for reduced CLI at the first UE during a time duration, where the downlink message may be received within the time duration.

In some examples of the method, apparatuses, and non-transitory computer-readable medium described herein, the set of CLI parameters associated with the first UE include a CLI reduction value and receiving the downlink message may be based on the CLI reduction value.

In some examples of the method, apparatuses, and non-transitory computer-readable medium described herein, the uplink message includes an indication of the second UE and receiving the downlink message may be based on the indication of the second UE.

In some examples of the method, apparatuses, and non-transitory computer-readable medium described herein, the uplink message includes a UCI message, a MAC-CE message, or both.

### BRIEF DESCRIPTION OF THE DRAWINGS

FIG. 1 illustrates an example of a wireless communications system that supports techniques for indicating an uplink power limit for full-duplex communications in accordance with one or more aspects of the present disclosure.

FIG. 2 illustrates an example of a wireless communications system that supports techniques for indicating an uplink power limit for full-duplex communications in accordance with one or more aspects of the present disclosure.

FIG. 3 illustrates an example of a wireless communications system that supports techniques for indicating an uplink power limit for full-duplex communications in accordance with one or more aspects of the present disclosure.

FIG. 4 illustrates an example of a process flow that supports techniques for indicating an uplink power limit for full-duplex communications in accordance with one or more aspects of the present disclosure.

FIGS. 5 and 6 show block diagrams of devices that support techniques for indicating an uplink power limit for full-duplex communications in accordance with one or more aspects of the present disclosure.

FIG. 7 shows a block diagram of a communications manager that supports techniques for indicating an uplink power limit for full-duplex communications in accordance with one or more aspects of the present disclosure.

FIG. 8 shows a diagram of a system including a device that supports techniques for indicating an uplink power limit for full-duplex communications in accordance with one or more aspects of the present disclosure.

FIGS. 9 and 10 show block diagrams of devices that support techniques for indicating an uplink power limit for full-duplex communications in accordance with one or more aspects of the present disclosure.

FIG. 11 shows a block diagram of a communications manager that supports techniques for indicating an uplink power limit for full-duplex communications in accordance with one or more aspects of the present disclosure.

FIG. 12 shows a diagram of a system including a device that supports techniques for indicating an uplink power limit for full-duplex communications in accordance with one or more aspects of the present disclosure.

FIGS. 13 through 17 show flowcharts illustrating methods that support techniques for indicating an uplink power limit for full-duplex communications in accordance with one or more aspects of the present disclosure.

### DETAILED DESCRIPTION

In some wireless communications systems, a user equipment (UE) may be configured to measure cross-link interference (CLI) attributable to signals received from other UEs. For example, a “victim” UE may experience CLI from signals transmitted by an “aggressor” UE in cases where uplink communications transmitted by the aggressor UE collide with downlink communications received by the victim UE. Moreover, some wireless communications systems enable network entities and other devices to perform full-duplex communications, in which the respective wireless devices are able to simultaneously perform downlink and uplink communications. Such full-duplex capabilities at network entities may increase the prevalence of CLI experienced by UEs within the wireless communications systems due to the simultaneous performance of downlink and uplink communications.

Conventional solutions for addressing CLI may be limited to the context of half-duplex communications, in which power control at a transmitting UE does not take into account interference the transmitting UE may be causing to a neighbor UE that is trying to receive at the same time. As such, conventional solutions for CLI mitigation may result in a transmitting UE performing uplink communications with unnecessarily high transmit power, which may interfere with simultaneous downlink reception at other UEs during full-duplex operation. Left unaddressed, CLI may decrease an efficiency and reliability of wireless communications within the wireless communications system.

Accordingly, aspects of the present disclosure are directed to signaling and techniques which enable network entities to control a transmission power of aggressor UEs to mitigate CLI experienced at victim UEs during a full-duplex operational mode at the network entities. For example, a victim UE may measure CLI attributable to signals received from an aggressor UE, and may transmit a CLI report to a network entity indicating the CLI experienced by the victim UE during a full-duplex operational mode at the network entity. The CLI report may also indicate CLI parameters of the victim UE, such as a CLI limit/range, a CLI reduction value, etc. The network entity may calculate an uplink power limit for the aggressor UE to use during the full-duplex operational mode at the network entity based on the received CLI report and CLI parameters. In particular, the network entity may calculate an uplink power limit for the aggressor UE during the full-duplex operational mode that will reduce or eliminate CLI experienced at the victim UE during the full-duplex operational mode, and may indicate the uplink power limit to the aggressor UE. Subsequently, the network entity can receive uplink messages from the aggressor UE using the uplink power limit, and simultaneously transmit downlink messages to the victim UE during the full-duplex communications mode at the network entity.

In some cases, the aggressor UE may report available uplink power values to the network entity, where the uplink power limit is determined based on the available uplink power values. The uplink power limit may be indicated to the aggressor UE as a power spectral density (PSD), a power backoff value, and/or a maximum absolute power value. In some cases, the victim UE may report different sets of CLI parameters for different operational modes at the network entity (e.g., first set of CLI parameters for a full-duplex operational mode, second set of parameters for a half-duplex operational mode). Similarly, the network entity may indicate different uplink power limits to the aggressor UE for different operational modes (e.g., first uplink power limit for full-duplex operational mode, second uplink power limit for half-duplex operational mode).

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for indicating an uplink power limit for full-duplex communications.

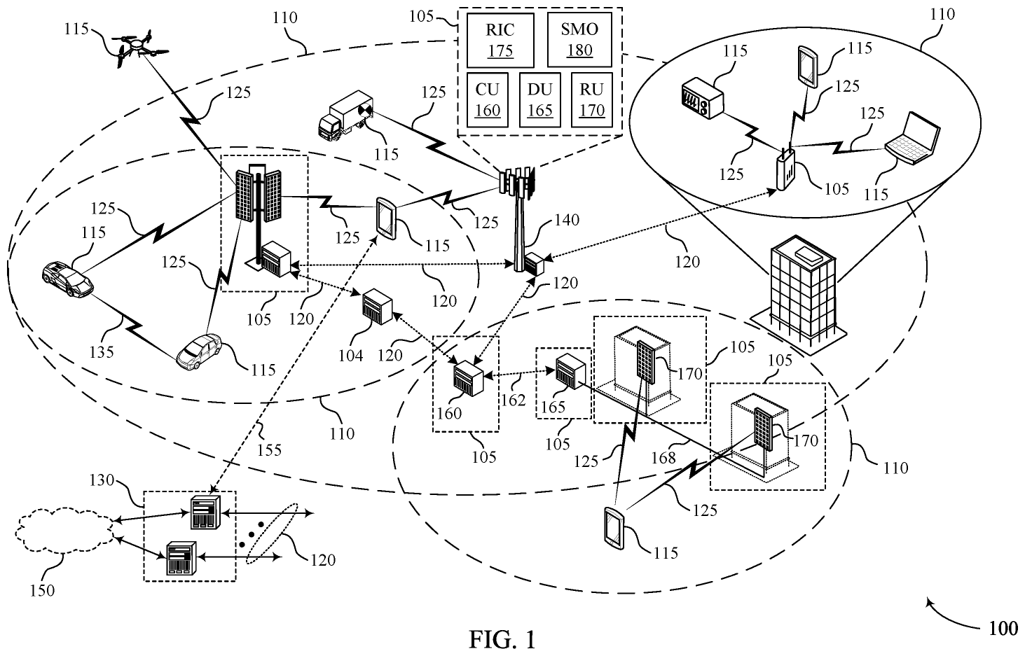

FIG. 1 illustrates an example of a wireless communications system 100 that supports techniques for indicating an uplink power limit for full-duplex communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for indicating an uplink power limit for full-duplex communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, the UEs 115, network entities 105, and other wireless devices of the wireless communications system 100 may support signaling and techniques which enable network entities 105 to control a transmission power of aggressor UEs 115 to mitigate CLI experienced at victim UEs 115 during a full-duplex operational mode at the network entities 105.

For example, a victim UE 115 of the wireless communications system 100 may measure CLI attributable to signals received from an aggressor UE 115, and may transmit a CLI report to a network entity 105 indicating the CLI experienced by the victim UE 115 during a full-duplex operational mode at the network entity 105. The CLI report may also indicate CLI parameters of the victim UE 115, such as a CLI limit/range, a CLI reduction value, etc. The network entity 105 may calculate an uplink power limit for the aggressor UE 115 to use during the full-duplex operational mode at the network entity 105 based on the received CLI report and CLI parameters. In particular, the network entity 105 may calculate an uplink power limit for the aggressor UE 115 during the full-duplex operational mode that will reduce or eliminate CLI experienced at the victim UE 115 during the full-duplex operational mode, and may indicate the uplink power limit to the aggressor UE 115. Subsequently, the network entity 105 can receive uplink messages from the aggressor UE 115 using the uplink power limit, and simultaneously transmit downlink messages to the victim UE 115 during the full-duplex communications mode at the network entity 105.

In some cases, the aggressor UE 115 may report available uplink power values to the network entity 105, where the uplink power limit is determined based on the available uplink power values. The uplink power limit may be indicated to the aggressor UE 115 as a PSD value, a power backoff value, and/or a maximum absolute power value. In some cases, the victim UE 115 may report different sets of CLI parameters for different operational modes at the network entity 105 (e.g., first set of CLI parameters for a full-duplex operational mode, second set of parameters for a half-duplex operational mode). Similarly, the network entity 105 may indicate different uplink power limits to the aggressor UE 115 for different operational modes (e.g., first uplink power limit for full-duplex operational mode, second uplink power limit for half-duplex operational mode).

Techniques described herein may enable network entities 105 to configure UEs 115 (e.g., aggressor UEs 115) with uplink power limits usable during full-duplex operational modes at the respective network entities 105. In this regard, techniques described herein may be used to control or limit the uplink transmit power of aggressor UEs 115 in order to reduce or eliminate CLI experienced by victim UEs 115 during full-duplex operational modes. Moreover, techniques described herein may enable UEs 115 to be configured with separate uplink power limits for different operational modes, such as full-duplex and half-duplex operational modes, thereby enabling transmit powers to be tailored to the respective operational modes to further reduce CLI. By reducing CLI within the wireless communications system 100, techniques described herein may reduce noise, prevent unnecessary retransmissions, and improve an overall efficiency and reliability of wireless communications.

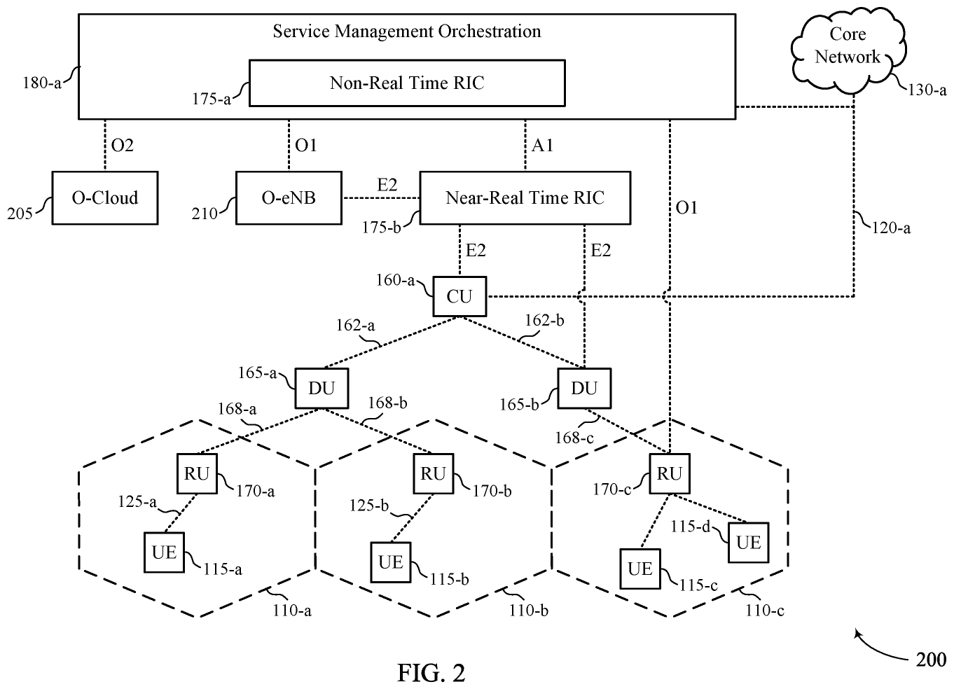

FIG. 2 illustrates an example of a network architecture 200 (e.g., a disaggregated base station architecture, a disaggregated RAN architecture) that supports techniques for indicating an uplink power limit for full-duplex communications in accordance with one or more aspects of the present disclosure. The network architecture 200 may illustrate an example for implementing one or more aspects of the wireless communications system 100.

The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165 (e.g., DUs 165-a, 165-b) via respective midhaul communication links 162 (e.g., midhaul communication links 162-a, 162-b) (e.g., an F1 interface). The DUs 165 may communicate with one or more RUs 170 (e.g., RUs 170-a, 170-b, 170-c) via respective fronthaul communication links 168 (e.g., fronthaul communication links 168-a, 168-b, 168-c). The RUs 170 may communicate with respective UEs 115 (e.g., UEs 115-a, 115-b, 115-c, 115-d) via one or more communication links 125 (e.g., communication links 125-a, 125-b). In some implementations, a UE 115 may be simultaneously served by multiple RUs 170. The UEs 115, RUs 170, DUs 165, CUs 160, or any combination thereof, may be positioned within one or more geographical coverage areas 110 (e.g., geographical coverage areas 110-a, 110-b, 110-c).

Each of the network entities 105 of the network architecture 200 (e.g., CUs 160-a, DUs 165, RUs 170, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

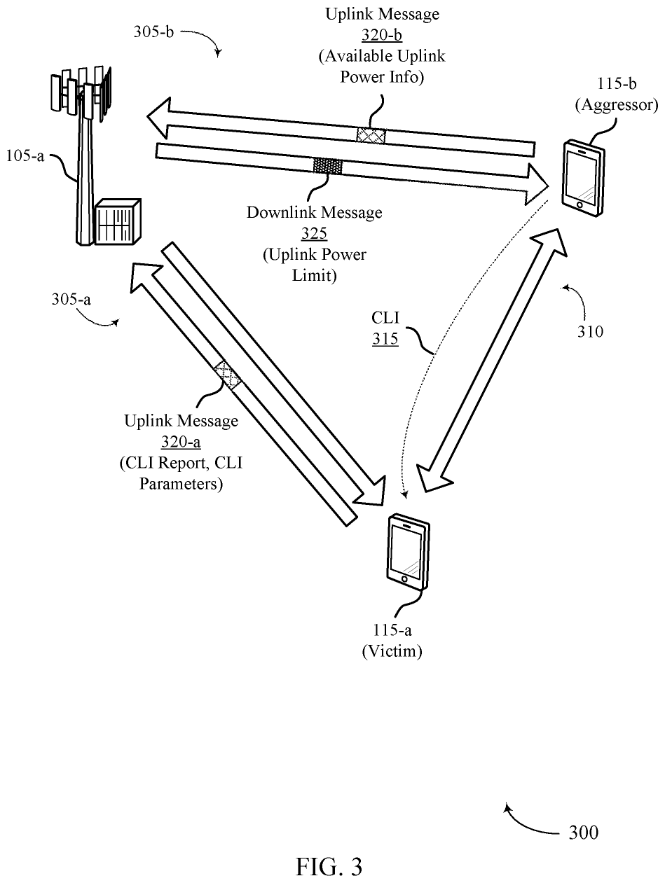

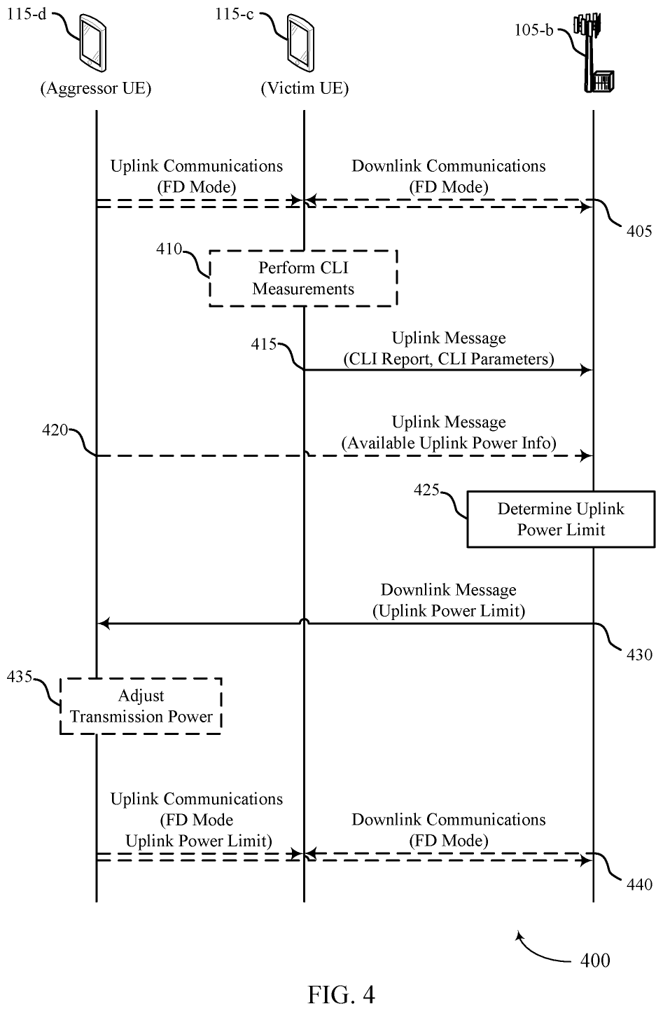

In some aspects, the wireless devices and components of the network architecture 200 may support signaling and techniques which enable network entities 105 to control a transmission power of aggressor UEs 115 to mitigate CLI experienced at victim UEs 115 during a full-duplex operational mode at the network entities 105. Attendant advantages of the techniques described herein will be further shown and described with respect to FIGS. 3-4.

FIG. 3 illustrates an example of a wireless communications system 300 that supports techniques for indicating an uplink power limit for full-duplex communications in accordance with one or more aspects of the present disclosure. In some examples, aspects of the wireless communications system 300 may implement, or be implemented by, aspects of the wireless communications system 100, the network architecture 200, or both.

The wireless communications system 300 may include a network entity 105-a, a first UE 115-a (e.g., victim UE 115-a), and a second UE 115-b (e.g., aggressor UE 115-b), which may be examples of network entities 105 and UEs 115 as described with reference to FIG. 1. The first UE 115-a and the second UE 115-b may communicate with the network entity 105-a using communication links 305-a and 305-b, respectively, which may be examples of NR or LTE links between the UEs 115-a, 115-b and the network entity 105-a. In some cases, the communication links 305-a, 305-b between the UEs 115-a, 115-b and the network entity 105-a may include examples of access links (e.g., Uu links) which may include bi-directional links that enable both uplink and downlink communication. For example, the first UE 115-a may transmit uplink signals, such as uplink control signals or uplink data signals, to one or more components of the network entity 105-a using the communication link 305-a, and one or more components of the network entity 105-a may transmit downlink signals, such as downlink control signals or downlink data signals, to the first UE 115-a using the communication link 305-a. Similarly, the first UE 115-a and the second UE 115-b may communicate with one another via a communication link 310, which may be an example of a sidelink communication link or a PC5 link.

As noted previously herein, UEs 115 may be configured to measure CLI attributable to signals received from other UEs 115. For example, as shown in FIG. 3, the first UE 115-a (e.g., “victim” UE 115-a) may experience CLI 315 attributable to signals transmitted by the second UE 115-b (e.g., “aggressor” UE 115-b) in cases where uplink communications transmitted by the second UE 115-b collide with downlink communications received by the first UE 115-a. The first UE 115-a may experience CLI 315 even in cases where the uplink communications transmitted by the second UE 115-b are not intended for the first UE 115-a, but are nonetheless received or intercepted by the first UE 115-a.

Moreover, some wireless communications systems enable network entities and other devices to perform both half-duplex and full-duplex communications. In the context of a half-duplex operational mode, a wireless device (e.g., network entity 105-a, UE 115) may be configured to transmit or receive in only one direction at a time. Comparatively, in the context of a full-duplex operational mode, a wireless devices may be able to simultaneously perform downlink and uplink communications. For example, the network entity 105-a of the wireless communications system 300 may support a full-duplex operational mode in which the network entity 105-a is able to simultaneously transmit downlink communications and receive uplink communications in Frequency Range 2 (FR2). Such full-duplex capabilities at network entities may increase the prevalence of CLI 315 experienced by UEs within the wireless communications systems due to the simultaneous performance of downlink and uplink communications.

The respective wireless devices (e.g., network entity 105-a, first UE 115-a, second UE 115-b) of the wireless communications system 300 may be configured to support half-duplex operational modes, full-duplex operational modes, or both. For example, in cases where the network entity 105-a supports full-duplex communications (e.g., supports a full-duplex operational mode), the network entity 105-a may be configured to transmit uplink communications via a first antenna panel, and simultaneously receive downlink communications via a second antenna panel. By way of another example, in cases where the first UE 115-a supports full-duplex communications, the first UE 115-a may be configured to transmit uplink communications to the network entity 105-a via a first antenna panel, and simultaneously receive downlink communications from the network entity 105-b via a second antenna panel. Further, during a full-duplex operational mode at the first UE 115-a, the first UE 115-a may be configured to transmit uplink signals to a first transmission-reception point (TRP), and simultaneously receive downlink signals from a second TRP.

The operational modes implemented by the respective wireless devices may be implemented independently from one another. For example, in some cases, the network entity 105-a may operate in a full-duplex operational mode while the first UE 115-a, the second UE 115-b, or both, operate in half-duplex operational modes. In such cases, the network entity 105-a may exhibit enhanced duplexing capability, and support single-frequency full-duplex (SFFD) and FDM/spatial division multiplexing (SDM) with resource block group (RBG) granularity.

In some aspects, the wireless communications system 300 may support full-duplex operations in the context of simultaneous operation of IAB node child and parent links. For example, as described with reference to FIGS. 1 and 2, the network entity 105-a may include a parent node including a mobile terminal (MT) and a DU, and an IAB node may include an MT and a DU. In such cases, the IAB node (and other components of the network entity 105) may support full-duplex communications via the MT and DU, where the respective components of the IAB node are configured to simultaneously transmit (Tx) or receive (Rx) wireless communication. In other words, IAB nodes may be configured to support full-duplex operation (e.g., Rx+Rx, Tx+Tx, Rx+Tx, Tx+Rx) via simultaneous operation between IAB-MT and IAB-DU links (e.g., MT Rx, DU Rx; MT Tx, DU Tx; MT Tx, DU Rx; MT Rx, DU Tx).

Full-duplex communications may provide a number of advantages. For example, full-duplex communications may enable wireless devices to simultaneously perform uplink and downlink communications (e.g., receive downlink signals in uplink-only slots), thereby resulting in a latency reduction. Moreover, full-duplex communications may result in a spectrum efficiency enhancement (e.g., per cell, per UE 115), and result in more efficient resource utilization and coverage enhancement. However, full-duplex capabilities may be conditional on a number of parameters, including beam separation, self-interference between uplink and downlink, and clutter echo. As such, when implementing full-duplex communications, respective components of the wireless communications system 300 may be configured to exchange coordinated parameters, including power control parameters, beam information, and Tx/Rx timing.

While full-duplex operational modes may enable a number of attendant advantages throughout the wireless communications system 300, increased prevalence of full-duplex communications may also result in increased CLI 315. For example, the network entity 105-a may operate in a full-duplex operational mode in which the network entity 105-a is able to receive uplink signals from the second UE 115-b and simultaneously transmit downlink signals to the first UE 115-a. As such, during the full-duplex operational mode at the network entity 105-a, uplink signals transmitted by the second UE 115-b may interfere with downlink signals that are received by the first UE 115-a, resulting in CLI 315.

Conventional solutions for addressing CLI 315 may be limited to the context of half-duplex communications, in which power control at a transmitting UE 115 (e.g., second UE 115-b) does not take into account interference the transmitting UE 115 may be causing to a neighbor UE 115 (e.g., first UE 115-a) that is trying to receive at the same time. As such, referring to FIG. 3, conventional solutions for CLI 315 mitigation may result in the second UE 115-b performing uplink communications with unnecessarily high transmit power, which may interfere with simultaneous downlink reception at the first UE 115-a during full-duplex operation at the network entity 105-a. Left unaddressed, CLI 315 may decrease an efficiency and reliability of wireless communications within the wireless communications system 300.

For example, in the context of uplink power control for a Uu link, transmit power of a respective UE 115 (e.g., second UE 115-b) may be controlled to meet a target SINR. In other words, the network entity 105-a may control a transmit power of the second UE 115-b in order to achieve a target SINR over the communication link 305-b. In such cases, conventional CLI mitigation techniques may not take into account the effect that the uplink transmit power has on communications received at the first UE 115-a during full-duplex operation at the network entity 105-a. As such, when conditions over the communication link 305-b change (e.g., when path loss/interference significantly changes), the uplink transmit power at the second UE 115-b may be too high to keep CLI 315 experienced at the first UE 115-a below a desired threshold. Furthermore, conventional CLI mitigation techniques enable the first UE 115-a to transmit CLI reports via Layer 3 (L3) signaling. However, controlling/mitigating CLI 315 via L3 CLI reports may exhibit significant latency, which may detrimentally affect latency-sensitive downlink traffic.

Accordingly, aspects of the present disclosure are directed to signaling and techniques which enable the network entity 105-a to control a transmission power of the second UE 115-b (e.g., aggressor UE 115-b) to mitigate CLI 315 experienced at the first UE 115-a (e.g., victim UE 115-a) during a full-duplex operational mode at the network entity 105-a. Techniques described herein may enable the network entity 105-a to determine an uplink power limit based on CLI parameters at the first UE 115-a during full-duplex operation at the network entity 105-a, thereby reducing CLI 315 during a full-duplex operational mode at the network entity 105-a. In particular, techniques described herein may support signaling and other techniques which enable the network entity 105-a to determine and signal an uplink power limit to the second UE 115-b, where the uplink power limit is configured to reduce or eliminate CLI 315 experienced at the first UE 115-a during a full-duplex operational mode at the network entity 105-a.

For example, referring to the wireless communications system 300 illustrated in FIG. 3, the network entity 105-a may perform wireless communications while operating in a full-duplex operational mode. In particular, the network entity 105-a may be configured to simultaneously transmit and receive wireless communications while operating in a full-duplex operational mode. For example, the network entity 105-a may transmit downlink communications to the first UE 115-a, and receive uplink communications from the second UE 115-b in accordance with the full-duplex operational mode at the network entity 105-a. In this example, the downlink communications and the uplink communications may at least partially overlap in time. For instance, the uplink and downlink communications at 405 may be performed within the same TTI.

As shown in FIG. 3, the overlapping (e.g., simultaneous) uplink and downlink communications at 405 may result in CLI 315 experienced at the first UE 115-a. For example, the uplink communications transmitted by the second UE 115-b may collide with downlink communications received by the victim UE 115-a, thereby resulting in CLI 315. As such, the first UE 115-a may perform CLI measurements attributable to signals received from the second UE 115-b (e.g., measure the CLI 315). In this regard, the first UE 115-a may perform CLI measurements based on receiving the downlink communications from the network entity 105-a, and based on receiving (e.g., intercepting) the uplink communications from the second UE 115-b. As such, the first UE 115-a may perform the CLI measurements based on the full-duplex operational mode at the network entity 105-a. The CLI measurements may include received signal strength indicator (RSSI) measurements, reference signal received power (RSRP) measurements, reference signal received quality (RSRQ) measurements, or any combination thereof.

In some aspects, the first UE 115-a may transmit a first uplink message 320-a to the network entity 105-a, where the first uplink message 320-a includes a CLI report associated with CLI 315 experienced at the first UE 115-a. In this regard, the first UE 115-a may transmit the first uplink message 320-a based on the communications performed during the full-duplex operational mode at the network entity 105-a, performing the CLI measurements, or both.

In some implementations, the first UE 115-a may transmit the first uplink message 320-a (e.g., CLI report) via L1 signaling, L3 signaling, or both. In this regard, in some aspects, the first uplink message 320-a may include an uplink control information (UCI) message, a MAC-CE message, or both. As described previously herein, in some cases, the use of L1 signaling for communicating CLI reports may reduce a latency of CLI reporting, which may thereby result in faster and more efficient CLI 315 mitigation at the first UE 115-a.

In some aspects, the first uplink message 320-a may include a CLI report and a set of CLI parameters associated with the first UE 115-a. The CLI report may indicate CLI measurements performed by the first UE 115-a. Moreover, the first uplink message 320 (e.g., CLI report) may include an indication of the second UE 115-b (e.g., UE identifier (ID)) to indicate that the CLI report and/or CLI measurements are associated with signals transmitted by the second UE 115-b.

The set of CLI parameters may include any parameters associated with CLI 315 experienced at the first UE 115-a (e.g., requested CLI control parameters). For example, the CLI parameters may include a CLI limit (e.g., maximum allowable CLI 315), a CLI range, a CLI reduction value, or any combination thereof. In this regard, the CLI parameters may include parameters associated with expected or allowable CLI 315, as well as a request to reduce CLI 315 by some value. In some cases, the first uplink message 320-a may include a request for the network entity 105-a to reduce CLI 315 experienced at the first UE 115-a over some time duration or time interval. That is, the first uplink message 320-a may indicate a time duration associated with an indicated CLI reduction value (e.g., request to reduce CLI 315 by X dB for the next ten slots).

In some implementations, the CLI report, the set of CLI parameters, or both, may be usable by the network entity 105-a to determine an uplink power limit associated with uplink communications transmitted by the second UE 115-b during the full-duplex operational mode at the network entity 105-a.

In some implementations, the first UE 115-a may indicate separate sets of CLI parameters which are associated with different operational modes at the network entity 105-a (e.g., full-duplex operational mode, half-duplex operational mode). In other words, in some cases, the first UE 115-a may indicate a first set of CLI parameters associated with the first UE 115-a during a full-duplex operational mode at the network entity 105-a (e.g., first CLI limit, first CLI range, first CLI reduction value), and a second set of CLI parameters associated with the first UE 115-a during a half-duplex operational mode at the network entity 105-a (e.g., second CLI limit, second CLI range, second CLI reduction value). In this regard, the first UE 115-a may indicate mode-specific CLI parameters.

Moreover, due to the fact that CLI 315 experienced at the first UE 115-a may be different during full-duplex and half-duplex operational modes at the network entity 105-a, the first UE 115-a may additionally or alternatively indicate different CLI reports (e.g., CLI measurements) associated with the respective operational modes at the network entity 105-a (e.g., first CLI report including CLI measurements during full-duplex communications at the network entity 105-a, second CLI report including CLI measurements during half-duplex communications at the network entity 105-a).

Similarly, in some implementations, the first UE 115-a may indicate separate sets of CLI parameters which are associated with different sets of resources (e.g., different BWPs). For example, in some cases, the first uplink message 320-a (and/or additional uplink messages 320) may indicate a first set of CLI parameters associated with a first set of resources (e.g., first BWP) usable during a full-duplex operational mode at the network entity 105-a, and a second set of CLI parameters associated with a second set of resources (e.g., second BWP) usable during the full-duplex operational mode at the network entity 105-a. Furthermore, the first UE 115-a may indicate separate CLI reports/CLI measurements associated with CLI 315 experienced by the first UE 115-a within the respective sets of resources (e.g., first CLI report associated with first BWP, second CLI report associated with second BWP).

In some aspects, the second UE 115-b may transmit a second uplink message 320-b (e.g., UCI, MAC-CE) to the network entity 105-a. In some aspects, the second uplink message 320-b may include or indicate available uplink power information associated with uplink communications transmitted by the second UE 115-b during the full-duplex operational mode at the network entity 105-a. Available uplink power information may include a maximum transmit power of the second UE 115-b, a power limit, and requested CLI control information. The second uplink message 320-b may include any information which may assist the network entity 105-a with determining uplink power limits for the second UE 115-b during full-duplex communications at the network entity 105-a. Stated differently, the second UE 115-b may inform the network entity 105-b as to the effect of any uplink power limit configured at the second UE 115-b.

In some aspects, the second UE 115-b may indicate (via the second uplink message 320-b), a set of parameters associated with the available uplink power information. Parameters associated with the available uplink power information may include, but are not limited to, a transmit beam at the second UE 115-b, a sub-band, a symbol, a resource pattern, or any combination thereof. In other words, available uplink power information can be indicated per beam, per sub-band, per symbol, per resource pattern, etc. For example, the second uplink message 320-b may indicate a first available uplink power value associated with uplink communications transmitted using a first transmit beam, and a second available uplink power value associated with uplink communications transmitted using a second transmit beam.

In some implementations, the network entity 105-a may determine or select an uplink power limit associated with uplink communications transmitted by the second UE 115-b during the full-duplex operational mode at the network entity 105-a. The network entity 105-a may determine the uplink power limit based on performing the full-duplex communications (e.g., communicating in accordance with the full-duplex operational mode), receiving the first uplink message 320-a from the first UE 115-a, receiving the second uplink message 320-b from the second UE 115-b, or any combination thereof.

In particular, the network entity 105-a may determine the uplink power limit based on the CLI report received from the first UE 115-a, the CLI parameters associated with the first UE 115-a, the available uplink power information received from the second UE 115-b, or any combination thereof. For example, in cases where the first uplink message 320-a indicates a CLI limit or CLI range associated with the first UE 115-a, the network entity 105-a may select the uplink power limit based on the CLI limit and/or CLI range. For instance, the network entity 105-a may select the uplink power limit such that CLI 315 experienced at the first UE 115-a during the full-duplex operational mode at the network entity 105-a is less than or equal to the CLI limit, less than or equal to an upper bound of the CLI range, or both. Moreover, the uplink power limit may be selected based on (e.g., in accordance with) the available uplink power information received via the second uplink message 320-b.

In some aspects, the network entity 105-a may transmit a downlink message 325 to the second UE 115-b, where the downlink message 325 indicates the uplink power limit. In this regard, the network entity 105-a may indicate the uplink power limit associated with uplink communications transmitted by the second UE 115-b during the full-duplex communications mode at the network entity 105-a. As such, the network entity 105-a may transmit the downlink message 325 indicating the uplink power limit based on performing the full-duplex communications, receiving the first uplink message 320-a from the first UE 115-a, receiving the second uplink message 320-b from the second UE 115-b, determining/selecting the uplink power limit, or any combination thereof.

In some aspects, the uplink power limit may include (or be indicated by) a PSD value, a power backoff value, a maximum absolute power, or any combination thereof. In some implementations, the network entity 105-a may indicate a time duration associated with the indicated uplink power limit. For example, as described previously herein, the first UE 115-a may request (via the first uplink message 320-a) a CLI reduction for some time interval (e.g., next ten slots). In such cases, the downlink message 325 may indicate that the uplink power limit is applicable for the time duration (e.g., next ten slots).

Similarly, the downlink message 325 may indicate one or more parameters associated with the uplink power limit. In particular, the uplink power limit may be based on (e.g., associated with) one or more parameters indicated via the uplink message 320-a, 320-b. For example, the downlink message 325 may indicate that the uplink power limit is associated with one or more transmit beams at the second UE 115-b, one or more sets of resources (e.g., sub-bands, symbols), one or more resource patterns, or any combination thereof. For instance, the network entity 105-a may indicate a first uplink power limit usable by the second UE 115-b when performing uplink communications within a first set of resources, and a second uplink power limit usable by the second UE 115-b when performing uplink communications within a second set of resources.

In some implementations, the network entity 105-a may indicate separate uplink power limits which are associated with different operational modes at the network entity 105-a (e.g., full-duplex operational mode, half-duplex operational mode). In particular, the first UE 115-a may experience differing levels of CLI 315 during full-duplex and half-duplex operational modes at the network entity 105-a. As such, the network entity 105-a may be configured to indicate separate uplink power limits usable by the second UE 115-b during the respective operational modes.

For example, in some cases, the network entity 105-a may indicate a first uplink power limit associated with uplink communications transmitted by the second UE 115-b during the full-duplex operational mode at the network entity 105-a, and a second uplink power limit associated with uplink communications transmitted by the second UE 115-b during the half-duplex operational mode at the network entity 105-a. In this regard, the second UE 115-b may be configured with mode-specific uplink power limits.

In some cases, the second UE 115-b may adjust a transmission power used for transmitting uplink communications during the full-duplex operational mode at the network entity 105-a. In particular, the second UE 115-b may adjust the transmission power based on (e.g., in accordance with) the uplink power limit received via the downlink message 325. For example, the second UE 115-b may adjust the transmission power used by the second UE 115-b such that the transmission power used during the full-duplex operational mode satisfies (e.g., is less than or equal to) the uplink power limit.

Subsequently, the network entity 105-a may perform wireless communications while operating in a full-duplex operational mode. In particular, the network entity 105-a may be configured to simultaneously transmit and receive wireless communications while operating in a full-duplex operational mode. Moreover, the network entity 105-a and the UEs 115-a, 115-b may perform the full-duplex communications in accordance with the uplink power limit. In this regard, the respective devices may perform communications based on transmitting/receiving the downlink message 325 including the uplink power limit, and adjusting the transmit power at the second UE 115-b.

For example, the network entity 105-a may transmit downlink communications to the first UE 115-a, and receive uplink communications from the second UE 115-b in accordance with the indicated uplink power limit and the full-duplex operational mode at the network entity 105-a. That is, the second UE 115-b may transmit uplink communications in accordance with the indicated uplink power limit. In this example, the downlink communications and the uplink communications may at least partially overlap in time. For instance, the uplink and downlink communications may be performed within the same TTI. In cases where the downlink message 325 indicates a time interval or time duration associated with the indicated uplink power limit, the full-duplex communications may be performed within the time interval and/or time duration.

The second UE 115-b may be configured to utilize the indicated uplink power limit to transmit uplink communications during the full-duplex communications mode at the network entity 105-a. Moreover, the second UE 115-b may be configured to utilize the indicated uplink power limit to transmit uplink communications associated with the parameters corresponding to the uplink power limit (e.g., associated sets of resources, transmit beams, resource patterns, etc.).

Comparatively, in cases where the network entity 105-a indicates a separate uplink power limit associated with half-duplex communications, the second UE 115-b may be configured to perform uplink communications using the separate uplink power limit during the half-duplex operational mode at the network entity 105-a. In other words, the second UE 115-b may be configured to utilize the uplink power limit associated with the respective operational mode (e.g., full-duplex operational mode, half-duplex operational mode) at the network entity 105-a.

Techniques described herein may enable the network entity 105-a to configure the second UE 115-b (e.g., aggressor UE 115-b) with uplink power limits usable during full-duplex operational modes at the network entity 105-a. In this regard, techniques described herein may be used to control or limit the uplink transmit power of the second UE 115-b in order to reduce or eliminate CLI experienced by the first UE 115-a (e.g., victim UE 115-a) during full-duplex operational modes. Moreover, techniques described herein may enable the second UE 115-b to be configured with separate uplink power limits for different operational modes, such as full-duplex and half-duplex operational modes, thereby enabling transmit powers to be tailored to the respective operational modes to further reduce CLI. By reducing CLI within the wireless communications system, techniques described herein may reduce noise, prevent unnecessary retransmissions, and improve an overall efficiency and reliability of wireless communications.

FIG. 4 illustrates an example of a process flow 400 that supports techniques for indicating an uplink power limit for full-duplex communications in accordance with one or more aspects of the present disclosure. In some examples, aspects of the process flow 400 may implement, or be implemented by, aspects of wireless communications system 100, network architecture 200, wireless communications system 300, or any combination thereof. In particular, the process flow 400 illustrates techniques for controlling and signaling uplink power limits of aggressor UEs 115 in the context of full-duplex communications at a network entity 105 as described with reference to FIGS. 1-3, among other aspects.

The process flow 400 may include a first UE 115-c, a second UE 115-b, and a network entity 105-b, which may be examples of UEs 115 and network entities 105 as described with reference to FIGS. 1-3. For example, the first UE 115-c and the second UE 115-d illustrated in FIG. 4 may be examples of the first UE 115-a and the second UE 115-b, respectively, as illustrated in FIG. 3. In this regard, the first UE 115-c may be an example of a victim UE 115, and the second UE 115-d may be an example of an aggressor UE 115. Similarly, the network entity 105-b illustrated in FIG. 4 may be an example of the network entity 105-a illustrated in FIG. 3.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 405, the network entity 105-b may perform wireless communications while operating in a full-duplex operational mode. In particular, the network entity 105-b may be configured to simultaneously transmit and receive wireless communications while operating in a full-duplex operational mode. For example, as shown in FIG. 4, the network entity 105-b may transmit downlink communications to the first UE 115-c, and receive uplink communications from the second UE 115-d in accordance with the full-duplex operational mode at the network entity 105-b. In this example, the downlink communications and the uplink communications may at least partially overlap in time. For instance, the uplink and downlink communications at 405 may be performed within the same TTI.

The overlapping (e.g., simultaneous) uplink and downlink communications at 405 may result in CLI experienced at the first UE 115-c. For example, the uplink communications transmitted by the second UE 115-d may collide with downlink communications received by the victim UE 115-c, thereby resulting in CLI.

At 410, the first UE 115-c may perform CLI measurements attributable to signals received from the second UE 115-d. In this regard, the first UE 115-c may perform CLI measurements based on receiving the downlink communications from the network entity 105-b, and based on receiving (e.g., intercepting) the uplink communications from the second UE 115-d. As such, the first UE 115-c may perform the CLI measurements based on the full-duplex operational mode at the network entity 105-b. The CLI measurements may include RSSI measurements, RSRP measurements, RSRQ measurements, or any combination thereof.

At 415, the first UE 115-c may transmit an uplink message to the network entity 105-b, where the uplink message includes a CLI report associated with CLI experienced at the first UE 115-c. In this regard, the first UE 115-c may transmit the uplink message at 405 based on the communications performed during the full-duplex operational mode at the network entity 105-b at 405, performing the CLI measurements at 410, or both.

In some implementations, the first UE 115-c may transmit the CLI report via L1 signaling, L3 signaling, or both. In this regard, in some aspects, the uplink message at 415 may include a UCI message, a MAC-CE message, or both. As described previously herein, in some cases, the use of L1 signaling for communicating CLI reports may reduce a latency of CLI reporting, which may thereby result in faster and more efficient CLI mitigation at the first UE 115-c.

In some aspects, the uplink message may include a CLI report and a set of CLI parameters associated with the first UE 115-c. The CLI report may indicate CLI measurements performed at 310. Moreover, the uplink message/CLI report may include an indication of the second UE 115-d (e.g., UE 115-d identifier) to indicate that the CLI report and/or CLI measurements are associated with signals transmitted by the second UE 115-d.

The set of CLI parameters may include any parameters associated with CLI experienced at the first UE 115-c. For example, the CLI parameters may include a CLI limit (e.g., maximum allowable CLI), a CLI range, a CLI reduction value, or any combination thereof. In this regard, the CLI parameters may include parameters associated with expected or allowable CLI, as well as a request to reduce CLI by some value. In some cases, the uplink message may include a request for the network entity 105-b to reduce CLI experienced at the first UE 115-c over some time duration. That is, the uplink message may indicate a time duration associated with an indicated CLI reduction value (e.g., request to reduce CLI by X dB for the next ten slots).

In some implementations, the CLI report, the set of CLI parameters, or both, may be usable by the network entity 105-b to determine an uplink power limit associated with uplink communications transmitted by the second UE 115-d during the full-duplex operational mode at the network entity 105-b.

In some implementations, the first UE 115-c may indicate separate sets of CLI parameters which are associated with different operational modes at the network entity 105-b (e.g., full-duplex operational mode, half-duplex operational mode). In other words, in some cases, the first UE 115-c may indicate a first set of CLI parameters associated with the first UE 115-c during a full-duplex operational mode at the network entity 105-b (e.g., first CLI limit, first CLI range, first CLI reduction value), and a second set of CLI parameters associated with the first UE 115-c during a half-duplex operational mode at the network entity 105-b (e.g., second CLI limit, second CLI range, second CLI reduction value). In this regard, the first UE 115-c may indicate mode-specific CLI parameters.

Moreover, due to the fact that CLI experienced at the first UE 115-c may be different during a full-duplex operational mode at the network entity 105-b and a half-duplex operational mode at the network entity 105-b, the first UE 115-c may additionally or alternatively indicate different CLI reports (e.g., CLI measurements) associated with the respective operational modes at the network entity 105-b (e.g., first CLI report including CLI measurements during full-duplex communications at the network entity 105-b, second CLI report including CLI measurements during half-duplex communications at the network entity 105-b).

Similarly, in some implementations, the first UE 115-c may indicate separate sets of CLI parameters which are associated with different sets of resources (e.g., different BWPs). For example, in some cases, the uplink message (and/or additional uplink messages) may indicate a first set of CLI parameters associated with a first set of resources (e.g., first BWP) usable during a full-duplex operational mode at the network entity 105-b, and a second set of CLI parameters associated with a second set of resources (e.g., second BWP) usable during the full-duplex operational mode at the network entity 105-b. Furthermore, the first UE 115-c may indicate separate CLI reports/CLI measurements associated with CLI experienced by the first UE 115-c within the respective sets of resources (e.g., first CLI report associated with first BWP, second CLI report associated with second BWP).

At 420, the second UE 115-d may transmit an uplink message (e.g., UCI, MAC-CE) to the network entity 105-b. In some aspects, the uplink message at 420 may include or indicate available uplink power information associated with uplink communications transmitted by the second UE 115-d during the full-duplex operational mode at the network entity 105-b. Available uplink power information may include a maximum transmit power of the second UE 115-d. The uplink message may include any information which may assist the network entity 105-b with determining uplink power limits for the second UE 115-d during full-duplex communications at the network entity 105-b.

In some aspects, the second UE 115-d may indicate (via the uplink message at 420), a set of parameters associated with the available uplink power information. Parameters associated with the available uplink power information may include, but are not limited to, a transmit beam at the second UE 115-d, a sub-band, a symbol, a resource pattern, or any combination thereof. For example, the uplink message at 420 may indicate a first available uplink power value associated with uplink communications transmitted using a first transmit beam, and a second available uplink power value associated with uplink communications transmitted using a second transmit beam.

At 425, the network entity 105-b may determine or select an uplink power limit associated with uplink communications transmitted by the second UE 115-d during the full-duplex operational mode at the network entity 105-b. The network entity 105-b may determine the uplink power limit at 425 based on performing the full-duplex communications at 405, receiving the uplink message from the first UE 115-c at 415, receiving the uplink message from the second UE 115-d at 420, or any combination thereof.

In particular, the network entity 105-b may determine the uplink power limit at 425 based on the CLI report received from the first UE 115-c, the CLI parameters associated with the first UE 115-c, the available uplink power information received from the second UE 115-d, or any combination thereof. For example, in cases where the first uplink message at 415 indicates a CLI limit or CLI range associated with the first UE 115-c, the network entity 105-b may select the uplink power limit at 425 based on the CLI limit and/or CLI range. For instance, the network entity 105-b may select the uplink power limit such that CLI experienced at the first UE 115-c during the full-duplex operational mode at the network entity 105-b is less than or equal to the CLI limit, less than or equal to an upper bound of the CLI range, or both. Moreover, the uplink power limit may be selected based on (e.g., in accordance with) the available uplink power information received via the second uplink message at 420.

At 430, the network entity 105-b may transmit a downlink message to the second UE 115-d, where the downlink message indicates the uplink power limit determined/selected at 425. In this regard, the network entity 105-b may indicate the uplink power limit associated with uplink communications transmitted by the second UE 115-d during the full-duplex communications mode at the network entity 105-b. As such, the network entity 105-b may transmit the downlink message indicating the uplink power limit at 430 based on performing the full-duplex communications at 405, receiving the uplink message from the first UE 115-c at 415, receiving the uplink message from the second UE 115-d at 420, determining the uplink power limit at 425, or any combination thereof.

In some aspects, the uplink power limit may include (or be indicated by) a PSD value, a power backoff value, a maximum absolute power, or any combination thereof. In some implementations, the network entity 105-b may indicate a time duration associated with the indicated uplink power limit. For example, as described previously herein, the first UE 115-c may request a CLI reduction for some time interval (e.g., next ten slots). In such cases, the downlink message at 430 may indicate that the uplink power limit is applicable for the time duration (e.g., next ten slots).

Similarly, the downlink message may indicate one or more parameters associated with the uplink power limit. In particular, the uplink power limit may be based on (e.g., associated with) one or more parameters indicated via the uplink messages at 415 and/or 420. For example, the downlink message may indicate that the uplink power limit is associated with one or more transmit beams at the second UE 115-d, one or more sets of resources (e.g., sub-bands, symbols), one or more resource patterns, or any combination thereof. For instance, the network entity 105-b may indicate a first uplink power limit usable by the second UE 115-d when performing uplink communications within a first set of resources, and a second uplink power limit usable by the second UE 115-d when performing uplink communications within a second set of resources.

In some implementations, the network entity 105-b may indicate separate uplink power limits which are associated with different operational modes at the network entity 105-b (e.g., full-duplex operational mode, half-duplex operational mode). In particular, the first UE 115-c may experience differing levels of CLI during full-duplex and half-duplex operational modes at the network entity 105-b. As such, the network entity 105-b may be configured to indicate separate uplink power limits usable by the second UE 115-d during the respective operational modes. For example, in some cases, the network entity 105-b may indicate a first uplink power limit associated with uplink communications transmitted by the second UE 115-d during the full-duplex operational mode at the network entity 105-b, and a second uplink power limit associated with uplink communications transmitted by the second UE 115-d during the half-duplex operational mode at the network entity 105-b. In this regard, the second UE 115-d may be configured with mode-specific uplink power limits.

At 435, the second UE 115-d may adjust a transmission power used for transmitting uplink communications during the full-duplex operational mode at the network entity 105-b. In particular, the second UE 115-d may adjust the transmission power based on (e.g., in accordance with) the uplink power limit received via the downlink message at 430. For example, the second UE 115-d may adjust the transmission power used by the second UE 115-d such that the transmission power used during the full-duplex operational mode satisfies (e.g., is less than or equal to) the uplink power limit.

At 440, the network entity 105-b may perform wireless communications while operating in a full-duplex operational mode. In particular, the network entity 105-b may be configured to simultaneously transmit and receive wireless communications while operating in a full-duplex operational mode. Moreover, the network entity 105-b and the UEs 115-c, 115-d may perform the full-duplex communications at 430 in accordance with the uplink power limit. In this regard, the respective devices may perform the communications at 430 based on transmitting/receiving the downlink message including the uplink power limit at 430, and adjusting the transmit power at 435.

For example, as shown in FIG. 4, the network entity 105-b may transmit downlink communications to the first UE 115-c, and receive uplink communications from the second UE 115-d in accordance with the indicated uplink power limit and the full-duplex operational mode at the network entity 105-b. That is, the second UE 115-d may transmit the uplink communications at 440 in accordance with the indicated uplink power limit. In this example, the downlink communications and the uplink communications may at least partially overlap in time. For instance, the uplink and downlink communications at 405 may be performed within the same TTI. In cases where the downlink message at 430 indicates a time interval or time duration associated with the indicated uplink power limit, the full-duplex communications performed at 435 may be performed within the time interval and/or time duration.

The second UE 115-d may be configured to utilize the indicated uplink power limit to transmit uplink communications during the full-duplex communications mode at the network entity 105-b. Moreover, the second UE 115-d may be configured to utilize the indicated uplink power limit to transmit uplink communications associated with the parameters corresponding to the uplink power limit (e.g., associated sets of resources, transmit beams, resource patterns, etc.).

Comparatively, in cases where the network entity 105-b indicates a separate uplink power limit associated with half-duplex communications, the second UE 115-d may be configured to perform uplink communications using the separate uplink power limit during the half-duplex operational mode at the network entity 105-b. In other words, the second UE 115-d may be configured to utilize the uplink power limit associated with the respective operational mode (e.g., full-duplex operational mode, half-duplex operational mode) at the network entity 105-b.

Techniques described herein may enable the network entity 105-b to configure the second UE 115-d (e.g., aggressor UE 115-d) with uplink power limits usable during full-duplex operational modes at the network entity 105-b. In this regard, techniques described herein may be used to control or limit the uplink transmit power of the second UE 115-d in order to reduce or eliminate CLI experienced by the first UE 115-c (e.g., victim UE 115-c) during full-duplex operational modes. Moreover, techniques described herein may enable the second UE 115-d to be configured with separate uplink power limits for different operational modes, such as full-duplex and half-duplex operational modes, thereby enabling transmit powers to be tailored to the respective operational modes to further reduce CLI. By reducing CLI within the wireless communications system, techniques described herein may reduce noise, prevent unnecessary retransmissions, and improve an overall efficiency and reliability of wireless communications.

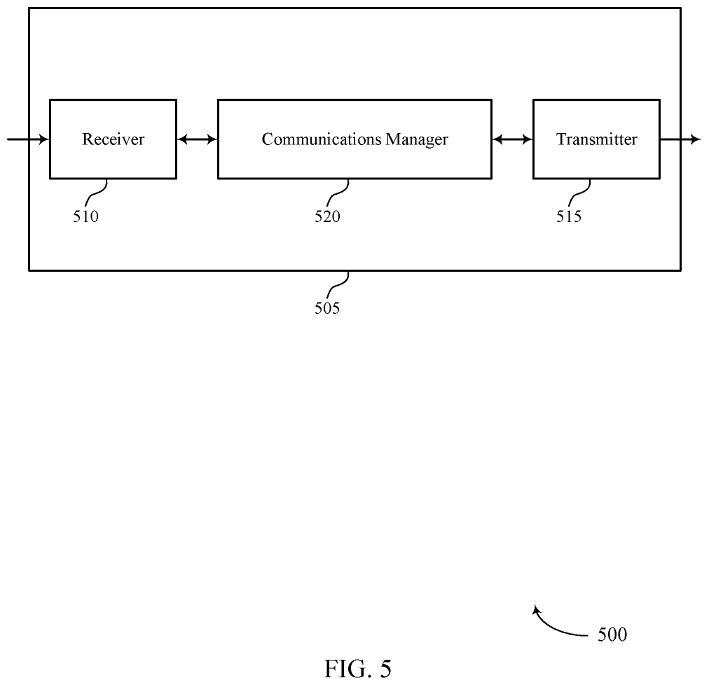

FIG. 5 shows a block diagram 500 of a device 505 that supports techniques for indicating an uplink power limit for full-duplex communications in accordance with one or more aspects of the present disclosure. The device 505 may be an example of aspects of a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of techniques for indicating an uplink power limit for full-duplex communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a network entity in accordance with examples as disclosed herein. For example, the communications manager 520 may be configured as or otherwise support a means for receiving, from a first UE a first uplink message indicating a CLI report associated with CLI experienced at the first UE and a set of CLI parameters associated with the first UE. The communications manager 520 may be configured as or otherwise support a means for transmitting, to a second UE based on the first uplink message, a first downlink message indicating an uplink power limit associated with uplink communications transmitted by the second UE during a full-duplex operational mode at the network entity. The communications manager 520 may be configured as or otherwise support a means for transmitting a second downlink message to the first UE during a TTI in accordance with the full-duplex operational mode and based on transmitting the first downlink message. The communications manager 520 may be configured as or otherwise support a means for receiving, from the second UE during the TTI, a second uplink message in accordance with the uplink power limit and the full-duplex operational mode.

By including or configuring the communications manager 520 in accordance with examples as described herein, the device 505 (e.g., a processor controlling or otherwise coupled with the receiver 510, the transmitter 515, the communications manager 520, or a combination thereof) may support techniques which enable network entities 105 to configure UEs 115 (e.g., aggressor UEs 115) with uplink power limits usable during full-duplex operational modes at the respective network entities 105. In this regard, techniques described herein may be used to control or limit the uplink transmit power of aggressor UEs 115 in order to reduce or eliminate CLI experienced by victim UEs 115 during full-duplex operational modes. Moreover, techniques described herein may enable UEs 115 to be configured with separate uplink power limits for different operational modes, such as full-duplex and half-duplex operational modes, thereby enabling transmit powers to be tailored to the respective operational modes to further reduce CLI. By reducing CLI within the wireless communications system, techniques described herein may reduce noise, prevent unnecessary retransmissions, and improve an overall efficiency and reliability of wireless communications.

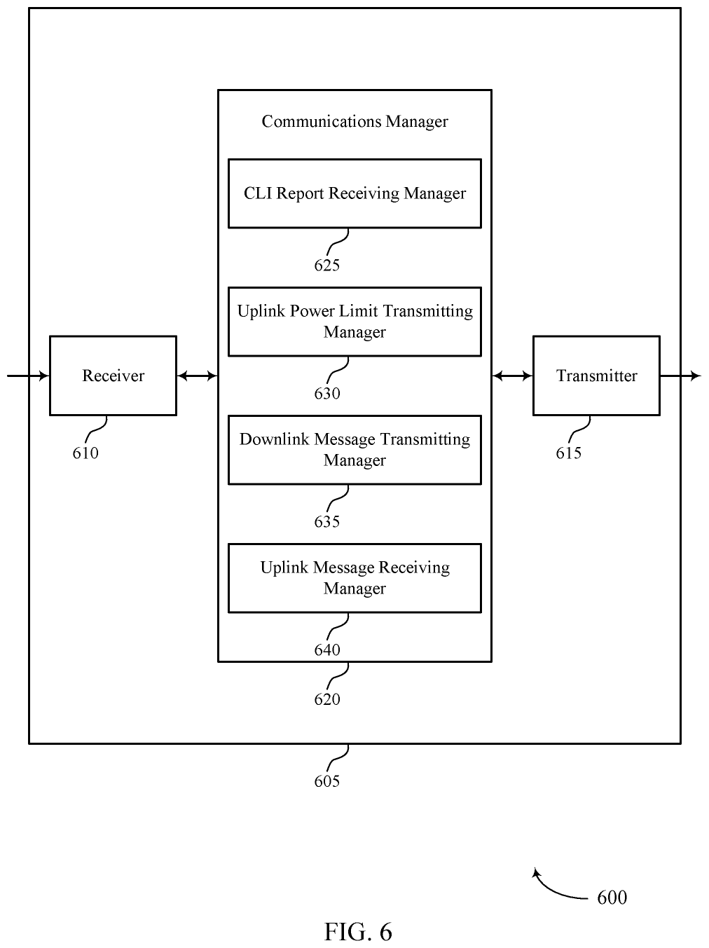

FIG. 6 shows a block diagram 600 of a device 605 that supports techniques for indicating an uplink power limit for full-duplex communications in accordance with one or more aspects of the present disclosure. The device 605 may be an example of aspects of a device 505 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of techniques for indicating an uplink power limit for full-duplex communications as described herein. For example, the communications manager 620 may include a CLI report receiving manager 625, an uplink power limit transmitting manager 630, a downlink message transmitting manager 635, an uplink message receiving manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a network entity in accordance with examples as disclosed herein. The CLI report receiving manager 625 may be configured as or otherwise support a means for receiving, from a first UE a first uplink message indicating a CLI report associated with CLI experienced at the first UE and a set of CLI parameters associated with the first UE. The uplink power limit transmitting manager 630 may be configured as or otherwise support a means for transmitting, to a second UE based on the first uplink message, a first downlink message indicating an uplink power limit associated with uplink communications transmitted by the second UE during a full-duplex operational mode at the network entity. The downlink message transmitting manager 635 may be configured as or otherwise support a means for transmitting a second downlink message to the first UE during a TTI in accordance with the full-duplex operational mode and based on transmitting the first downlink message. The uplink message receiving manager 640 may be configured as or otherwise support a means for receiving, from the second UE during the TTI, a second uplink message in accordance with the uplink power limit and the full-duplex operational mode.

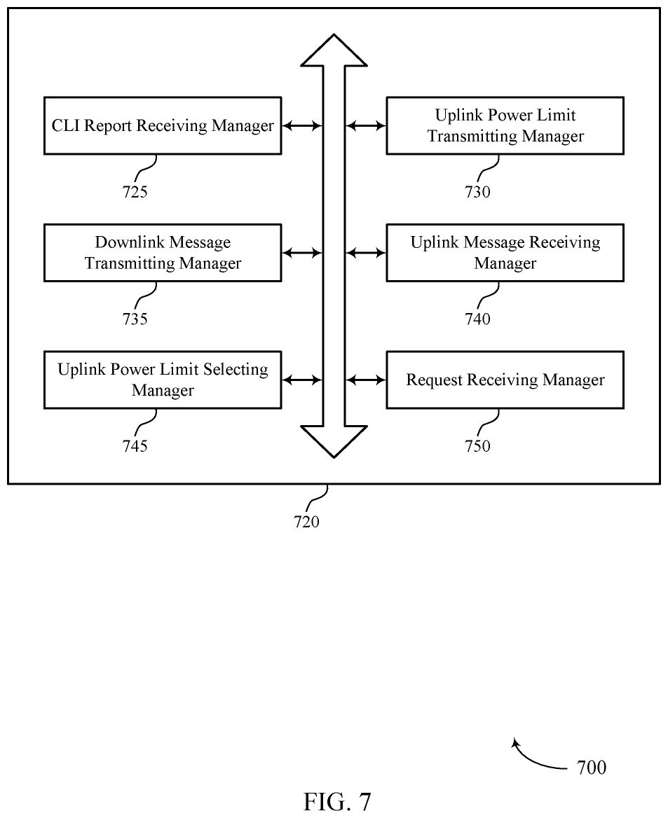

FIG. 7 shows a block diagram 700 of a communications manager 720 that supports techniques for indicating an uplink power limit for full-duplex communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for indicating an uplink power limit for full-duplex communications as described herein. For example, the communications manager 720 may include a CLI report receiving manager 725, an uplink power limit transmitting manager 730, a downlink message transmitting manager 735, an uplink message receiving manager 740, an uplink power limit selecting manager 745, a request receiving manager 750, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communication at a network entity in accordance with examples as disclosed herein. The CLI report receiving manager 725 may be configured as or otherwise support a means for receiving, from a first UE a first uplink message indicating a CLI report associated with CLI experienced at the first UE and a set of CLI parameters associated with the first UE. The uplink power limit transmitting manager 730 may be configured as or otherwise support a means for transmitting, to a second UE based on the first uplink message, a first downlink message indicating an uplink power limit associated with uplink communications transmitted by the second UE during a full-duplex operational mode at the network entity. The downlink message transmitting manager 735 may be configured as or otherwise support a means for transmitting a second downlink message to the first UE during a TTI in accordance with the full-duplex operational mode and based on transmitting the first downlink message. The uplink message receiving manager 740 may be configured as or otherwise support a means for receiving, from the second UE during the TTI, a second uplink message in accordance with the uplink power limit and the full-duplex operational mode.

In some examples, the CLI report receiving manager 725 may be configured as or otherwise support a means for receiving, via the CLI report of the first uplink message, an indication of a CLI limit, a CLI range, or both, where the set of CLI parameters includes the CLI limit, the CLI range, or both. In some examples, the uplink power limit selecting manager 745 may be configured as or otherwise support a means for selecting the uplink power limit associated with the full-duplex operational mode based on the CLI limit, the CLI range, or both, where transmitting the first downlink message is based on the selecting.

In some examples, the uplink power limit is selected such that CLI experienced at the first UE that is attributable to uplink communications transmitted by the second UE during the full-duplex operational mode is less than or equal to the CLI limit, an upper bound of the CLI range, or both.

In some examples, the set of CLI parameters is associated with the full-duplex operational mode at the network entity, and the CLI report receiving manager 725 may be configured as or otherwise support a means for receiving, via the first uplink message, an additional uplink message, or both, an additional set of CLI parameters associated with the first UE and a half-duplex operational mode at the network entity. In some examples, the set of CLI parameters is associated with the full-duplex operational mode at the network entity, and the uplink power limit transmitting manager 730 may be configured as or otherwise support a means for transmitting, to the second UE based on the additional set of CLI parameters, an additional uplink power limit associated with uplink communications transmitted by the second UE during the half-duplex operational mode.

In some examples, the set of CLI parameters is associated with a first set of resources usable during the full-duplex operational mode, and the CLI report receiving manager 725 may be configured as or otherwise support a means for receiving, via the first uplink message, an additional uplink message, or both, an additional set of CLI parameters associated with a second set of resources usable during the full-duplex operational mode at the network entity, where the uplink power limit is based on the set of CLI parameters, the additional set of CLI parameters, or both.

In some examples, the request receiving manager 750 may be configured as or otherwise support a means for receiving, via the first uplink message, a request for reduced CLI at the first UE during a time duration. In some examples, the uplink power limit transmitting manager 730 may be configured as or otherwise support a means for transmitting, via the first downlink message, an indication of the time duration associated with the uplink power limit, where the TTI is included within the time duration.

In some examples, the uplink message receiving manager 740 may be configured as or otherwise support a means for receiving, from the second UE, a second uplink message indicating available uplink power information associated with uplink communications transmitted by the second UE during the full-duplex operational mode, where the uplink power limit is based on the available uplink power information.

In some examples, the uplink message receiving manager 740 may be configured as or otherwise support a means for receiving, via the second uplink message, an indication of one or more parameters associated with the available uplink power information, the one or more parameters including a transmit beam at the second UE, a sub-band, a symbol, a resource pattern, or any combination thereof, where the uplink power limit is based on the one or more parameters.

In some examples, the uplink power limit includes an indication of a PSD, a power backoff value, a maximum absolute power value, or any combination thereof. In some examples, the CLI report includes one or more CLI measurements performed by the first UE on signals received from the second UE during the full-duplex operational mode. In some examples, the uplink power limit is based on the one or more CLI measurements. In some examples, the set of CLI parameters associated with the first UE include a CLI reduction value. In some examples, the uplink power limit is based on the CLI reduction value.

In some examples, the first uplink message includes an indication of the second UE. In some examples, transmitting the first downlink message to the second UE is based on the indication of the second UE. In some examples, the first uplink message includes an UCI message, a MAC-CE message, or both.

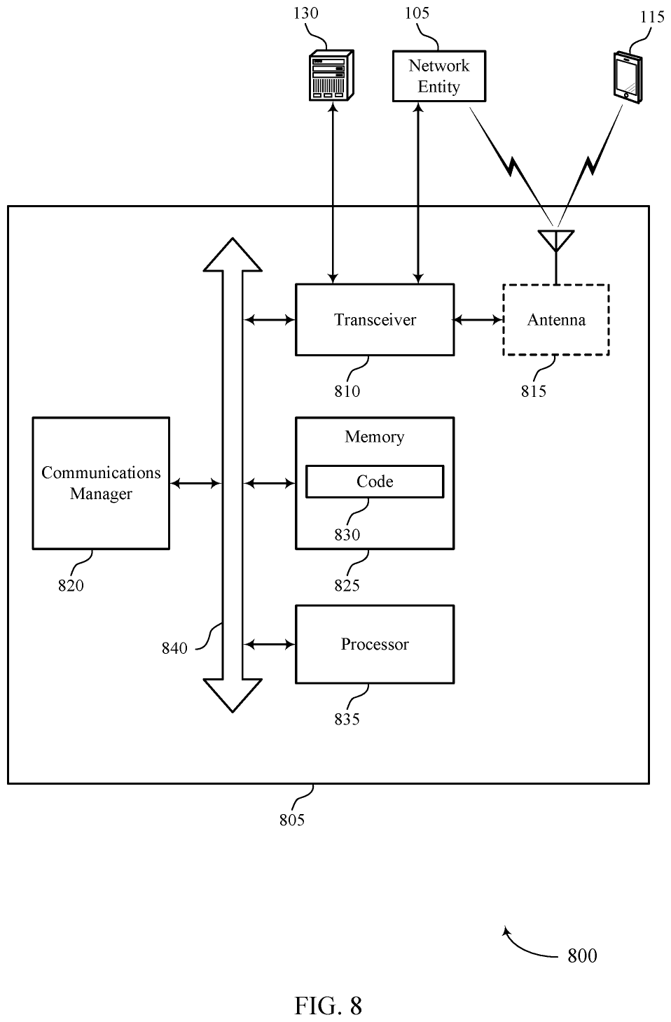

FIG. 8 shows a diagram of a system 800 including a device 805 that supports techniques for indicating an uplink power limit for full-duplex communications in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. The transceiver 810, or the transceiver 810 and one or more antennas 815 or wired interfaces, where applicable, may be an example of a transmitter 515, a transmitter 615, a receiver 510, a receiver 610, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting techniques for indicating an uplink power limit for full-duplex communications). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communication at a network entity in accordance with examples as disclosed herein. For example, the communications manager 820 may be configured as or otherwise support a means for receiving, from a first UE a first uplink message indicating a CLI report associated with CLI experienced at the first UE and a set of CLI parameters associated with the first UE. The communications manager 820 may be configured as or otherwise support a means for transmitting, to a second UE based on the first uplink message, a first downlink message indicating an uplink power limit associated with uplink communications transmitted by the second UE during a full-duplex operational mode at the network entity. The communications manager 820 may be configured as or otherwise support a means for transmitting a second downlink message to the first UE during a TTI in accordance with the full-duplex operational mode and based on transmitting the first downlink message. The communications manager 820 may be configured as or otherwise support a means for receiving, from the second UE during the TTI, a second uplink message in accordance with the uplink power limit and the full-duplex operational mode.

By including or configuring the communications manager 820 in accordance with examples as described herein, the device 805 may support techniques which enable network entities 105 to configure UEs 115 (e.g., aggressor UEs 115) with uplink power limits usable during full-duplex operational modes at the respective network entities 105. In this regard, techniques described herein may be used to control or limit the uplink transmit power of aggressor UEs 115 in order to reduce or eliminate CLI experienced by victim UEs 115 during full-duplex operational modes. Moreover, techniques described herein may enable UEs 115 to be configured with separate uplink power limits for different operational modes, such as full-duplex and half-duplex operational modes, thereby enabling transmit powers to be tailored to the respective operational modes to further reduce CLI. By reducing CLI within the wireless communications system, techniques described herein may reduce noise, prevent unnecessary retransmissions, and improve an overall efficiency and reliability of wireless communications.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the processor 835, the memory 825, the code 830, the transceiver 810, or any combination thereof. For example, the code 830 may include instructions executable by the processor 835 to cause the device 805 to perform various aspects of techniques for indicating an uplink power limit for full-duplex communications as described herein, or the processor 835 and the memory 825 may be otherwise configured to perform or support such operations.

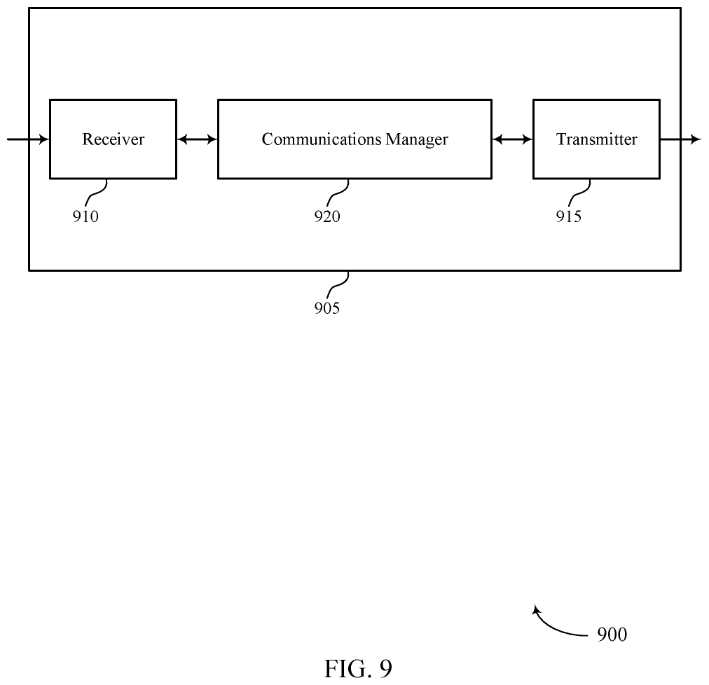

FIG. 9 shows a block diagram 900 of a device 905 that supports techniques for indicating an uplink power limit for full-duplex communications in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for indicating an uplink power limit for full-duplex communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for indicating an uplink power limit for full-duplex communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for indicating an uplink power limit for full-duplex communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. For example, the communications manager 920 may be configured as or otherwise support a means for transmitting a first uplink message to a network entity during a full-duplex operational mode at the network entity. The communications manager 920 may be configured as or otherwise support a means for receiving, from the network entity based on the first uplink message, a downlink message indicating an uplink power limit associated with uplink communications transmitted by the UE during the full-duplex operational mode at the network entity. The communications manager 920 may be configured as or otherwise support a means for adjusting a transmission power used for transmitting uplink messages during the full-duplex operational mode based on the uplink power limit. The communications manager 920 may be configured as or otherwise support a means for transmitting a second uplink message to the network entity in accordance with the uplink power limit and the full-duplex operational mode at the network entity.

Additionally, or alternatively, the communications manager 920 may support wireless communication at a first UE in accordance with examples as disclosed herein. For example, the communications manager 920 may be configured as or otherwise support a means for performing one or more CLI measurements associated with uplink communications transmitted by a second UE to a network entity during a full-duplex operational mode at the network entity. The communications manager 920 may be configured as or otherwise support a means for transmitting, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode. The communications manager 920 may be configured as or otherwise support a means for receiving a downlink message from the network entity during the full-duplex operational mode and based on the uplink message.

By including or configuring the communications manager 920 in accordance with examples as described herein, the device 905 (e.g., a processor controlling or otherwise coupled with the receiver 910, the transmitter 915, the communications manager 920, or a combination thereof) may support techniques which enable network entities 105 to configure UEs 115 (e.g., aggressor UEs 115) with uplink power limits usable during full-duplex operational modes at the respective network entities 105. In this regard, techniques described herein may be used to control or limit the uplink transmit power of aggressor UEs 115 in order to reduce or eliminate CLI experienced by victim UEs 115 during full-duplex operational modes. Moreover, techniques described herein may enable UEs 115 to be configured with separate uplink power limits for different operational modes, such as full-duplex and half-duplex operational modes, thereby enabling transmit powers to be tailored to the respective operational modes to further reduce CLI. By reducing CLI within the wireless communications system, techniques described herein may reduce noise, prevent unnecessary retransmissions, and improve an overall efficiency and reliability of wireless communications.

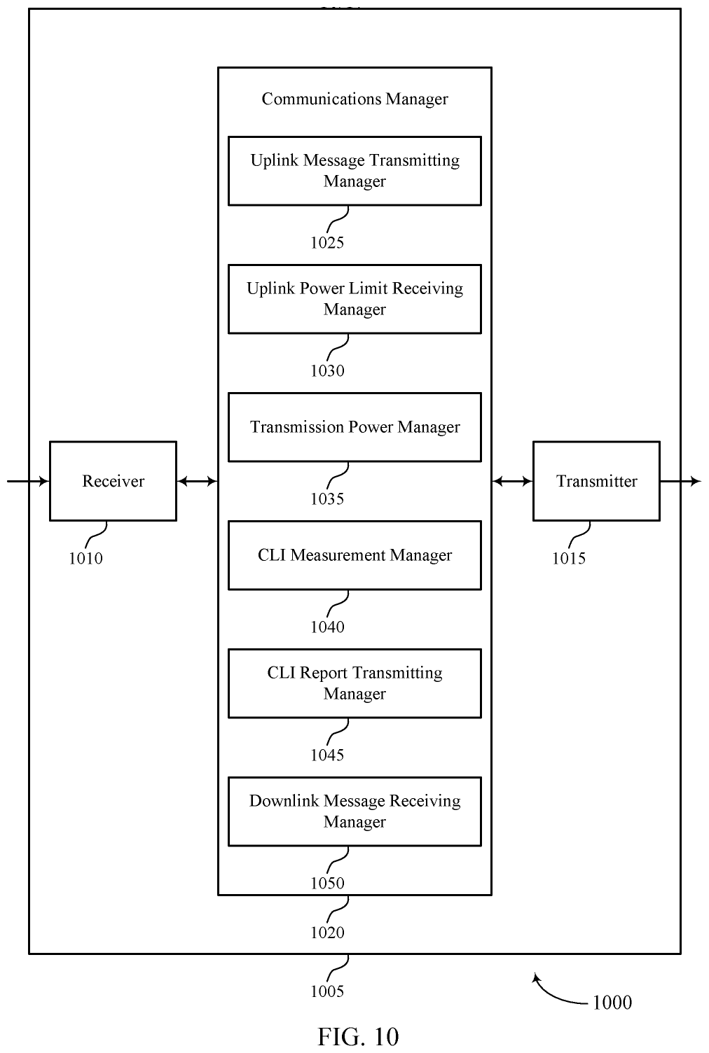

FIG. 10 shows a block diagram 1000 of a device 1005 that supports techniques for indicating an uplink power limit for full-duplex communications in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for indicating an uplink power limit for full-duplex communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for indicating an uplink power limit for full-duplex communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for indicating an uplink power limit for full-duplex communications as described herein. For example, the communications manager 1020 may include an uplink message transmitting manager 1025, an uplink power limit receiving manager 1030, a transmission power manager 1035, a CLI measurement manager 1040, a CLI report transmitting manager 1045, a downlink message receiving manager 1050, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The uplink message transmitting manager 1025 may be configured as or otherwise support a means for transmitting a first uplink message to a network entity during a full-duplex operational mode at the network entity. The uplink power limit receiving manager 1030 may be configured as or otherwise support a means for receiving, from the network entity based on the first uplink message, a downlink message indicating an uplink power limit associated with uplink communications transmitted by the UE during the full-duplex operational mode at the network entity. The transmission power manager 1035 may be configured as or otherwise support a means for adjusting a transmission power used for transmitting uplink messages during the full-duplex operational mode based on the uplink power limit. The uplink message transmitting manager 1025 may be configured as or otherwise support a means for transmitting a second uplink message to the network entity in accordance with the uplink power limit and the full-duplex operational mode at the network entity.

Additionally, or alternatively, the communications manager 1020 may support wireless communication at a first UE in accordance with examples as disclosed herein. The CLI measurement manager 1040 may be configured as or otherwise support a means for performing one or more CLI measurements associated with uplink communications transmitted by a second UE to a network entity during a full-duplex operational mode at the network entity. The CLI report transmitting manager 1045 may be configured as or otherwise support a means for transmitting, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode. The downlink message receiving manager 1050 may be configured as or otherwise support a means for receiving a downlink message from the network entity during the full-duplex operational mode and based on the uplink message.

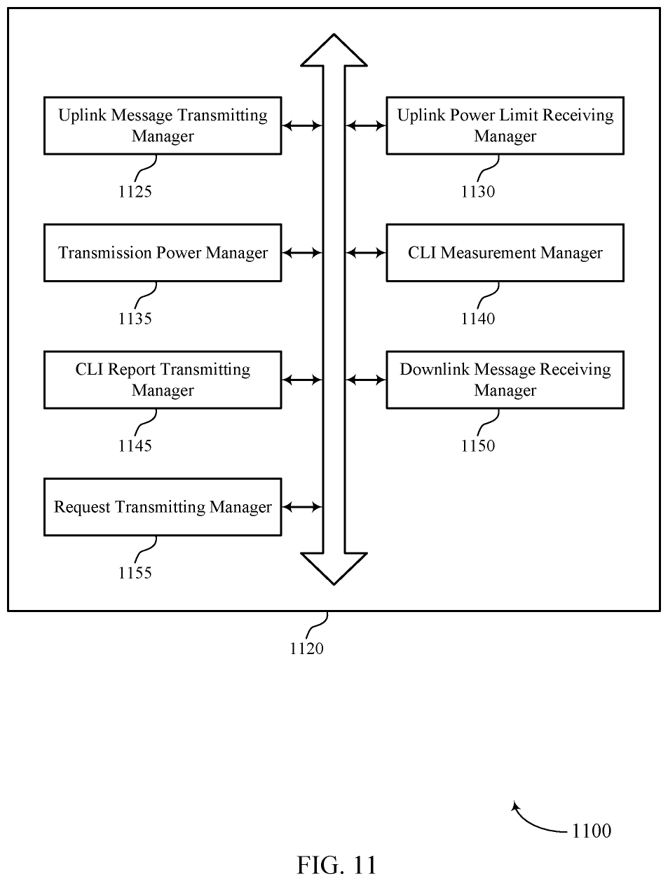

FIG. 11 shows a block diagram 1100 of a communications manager 1120 that supports techniques for indicating an uplink power limit for full-duplex communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for indicating an uplink power limit for full-duplex communications as described herein. For example, the communications manager 1120 may include an uplink message transmitting manager 1125, an uplink power limit receiving manager 1130, a transmission power manager 1135, a CLI measurement manager 1140, a CLI report transmitting manager 1145, a downlink message receiving manager 1150, a request transmitting manager 1155, or any combination thereof. Each of these components may communicate, directly or indirectly, with one another (e.g., via one or more buses).

The communications manager 1120 may support wireless communication at a UE in accordance with examples as disclosed herein. The uplink message transmitting manager 1125 may be configured as or otherwise support a means for transmitting a first uplink message to a network entity during a full-duplex operational mode at the network entity. The uplink power limit receiving manager 1130 may be configured as or otherwise support a means for receiving, from the network entity based on the first uplink message, a downlink message indicating an uplink power limit associated with uplink communications transmitted by the UE during the full-duplex operational mode at the network entity. The transmission power manager 1135 may be configured as or otherwise support a means for adjusting a transmission power used for transmitting uplink messages during the full-duplex operational mode based on the uplink power limit. In some examples, the uplink message transmitting manager 1125 may be configured as or otherwise support a means for transmitting a second uplink message to the network entity in accordance with the uplink power limit and the full-duplex operational mode at the network entity.

In some examples, the uplink message transmitting manager 1125 may be configured as or otherwise support a means for transmitting, to the network entity via the first uplink message, an additional uplink message, or both, an indication of available uplink power information associated with uplink communications transmitted by the UE during the full-duplex operational mode, where the uplink power limit is based on the available uplink power information.

In some examples, the uplink message transmitting manager 1125 may be configured as or otherwise support a means for transmitting, via the first uplink message, the additional uplink message, or both, an indication of one or more parameters associated with the available uplink power information, the one or more parameters including a transmit beam at the UE, a sub-band, a symbol, a resource pattern, or any combination thereof, where the uplink power limit is based on the one or more parameters.

In some examples, the uplink power limit receiving manager 1130 may be configured as or otherwise support a means for receiving, via the downlink message, an additional downlink message, or both, an additional uplink power limit associated with uplink communications transmitted by the UE during a half-duplex operational mode of the network entity. In some examples, the uplink message transmitting manager 1125 may be configured as or otherwise support a means for transmitting a third uplink message to the network entity in accordance with the additional uplink power limit and the half-duplex operational mode at the network entity.

In some examples, the uplink power limit receiving manager 1130 may be configured as or otherwise support a means for receiving, via the downlink message, an indication of a time duration associated with the uplink power limit, where adjusting the transmission power, transmitting the second uplink message, or both, are based on the time duration. In some examples, the uplink power limit includes an indication of a PSD, a power backoff value, a maximum absolute power value, or any combination thereof.

Additionally, or alternatively, the communications manager 1120 may support wireless communication at a first UE in accordance with examples as disclosed herein. The CLI measurement manager 1140 may be configured as or otherwise support a means for performing one or more CLI measurements associated with uplink communications transmitted by a second UE to a network entity during a full-duplex operational mode at the network entity. The CLI report transmitting manager 1145 may be configured as or otherwise support a means for transmitting, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode. The downlink message receiving manager 1150 may be configured as or otherwise support a means for receiving a downlink message from the network entity during the full-duplex operational mode and based on the uplink message.

In some examples, the CLI report transmitting manager 1145 may be configured as or otherwise support a means for transmitting, via the uplink message, an indication of a CLI limit, a CLI range, or both, where the set of CLI parameters include the CLI limit, the CLI range, or both.

In some examples, the set of CLI parameters is associated with the full-duplex operational mode at the network entity, and the CLI report transmitting manager 1145 may be configured as or otherwise support a means for transmitting, via the uplink message, an additional uplink message, or both, an additional set of CLI parameters associated with the first UE and a half-duplex operational mode at the network entity. In some examples, the set of CLI parameters is associated with the full-duplex operational mode at the network entity, and the downlink message receiving manager 1150 may be configured as or otherwise support a means for receiving an additional downlink message from the network entity during the half-duplex operational mode and based on the additional set of CLI parameters.

In some examples, the set of CLI parameters is associated with a first set of resources usable during the full-duplex operational mode, and the CLI report transmitting manager 1145 may be configured as or otherwise support a means for transmitting, via the uplink message, an additional uplink message, or both, an additional set of CLI parameters associated with a second set of resources usable during the full-duplex operational mode at the network entity, where the downlink message is based on the set of CLI parameters, the additional set of CLI parameters, or both.

In some examples, the request transmitting manager 1155 may be configured as or otherwise support a means for transmitting, via the uplink message, a request for reduced CLI at the first UE during a time duration, where the downlink message is received within the time duration.

In some examples, the set of CLI parameters associated with the first UE include a CLI reduction value. In some examples, receiving the downlink message is based on the CLI reduction value. In some examples, the uplink message includes an indication of the second UE. In some examples, receiving the downlink message is based on the indication of the second UE. In some examples, the uplink message includes an UCI message, a MAC-CE message, or both.

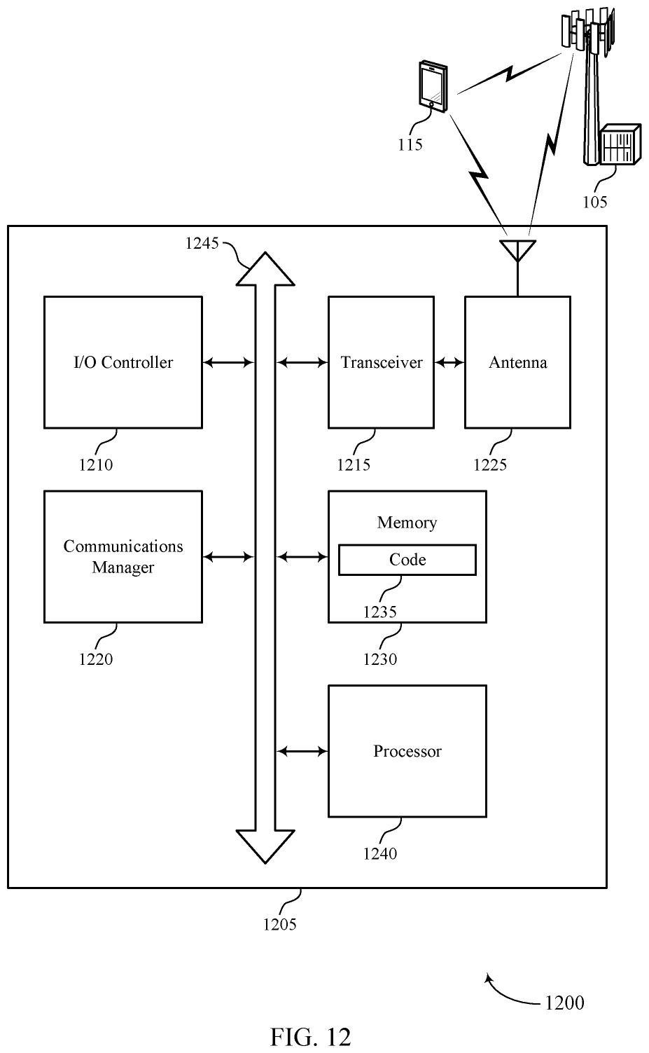

FIG. 12 shows a diagram of a system 1200 including a device 1205 that supports techniques for indicating an uplink power limit for full-duplex communications in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for indicating an uplink power limit for full-duplex communications). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for transmitting a first uplink message to a network entity during a full-duplex operational mode at the network entity. The communications manager 1220 may be configured as or otherwise support a means for receiving, from the network entity based on the first uplink message, a downlink message indicating an uplink power limit associated with uplink communications transmitted by the UE during the full-duplex operational mode at the network entity. The communications manager 1220 may be configured as or otherwise support a means for adjusting a transmission power used for transmitting uplink messages during the full-duplex operational mode based on the uplink power limit. The communications manager 1220 may be configured as or otherwise support a means for transmitting a second uplink message to the network entity in accordance with the uplink power limit and the full-duplex operational mode at the network entity.

Additionally, or alternatively, the communications manager 1220 may support wireless communication at a first UE in accordance with examples as disclosed herein. For example, the communications manager 1220 may be configured as or otherwise support a means for performing one or more CLI measurements associated with uplink communications transmitted by a second UE to a network entity during a full-duplex operational mode at the network entity. The communications manager 1220 may be configured as or otherwise support a means for transmitting, to the network entity and based on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode. The communications manager 1220 may be configured as or otherwise support a means for receiving a downlink message from the network entity during the full-duplex operational mode and based on the uplink message.

By including or configuring the communications manager 1220 in accordance with examples as described herein, the device 1205 may support techniques which enable network entities 105 to configure UEs 115 (e.g., aggressor UEs 115) with uplink power limits usable during full-duplex operational modes at the respective network entities 105. In this regard, techniques described herein may be used to control or limit the uplink transmit power of aggressor UEs 115 in order to reduce or eliminate CLI experienced by victim UEs 115 during full-duplex operational modes. Moreover, techniques described herein may enable UEs 115 to be configured with separate uplink power limits for different operational modes, such as full-duplex and half-duplex operational modes, thereby enabling transmit powers to be tailored to the respective operational modes to further reduce CLI. By reducing CLI within the wireless communications system, techniques described herein may reduce noise, prevent unnecessary retransmissions, and improve an overall efficiency and reliability of wireless communications.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for indicating an uplink power limit for full-duplex communications as described herein, or the processor 1240 and the memory 1230 may be otherwise configured to perform or support such operations.

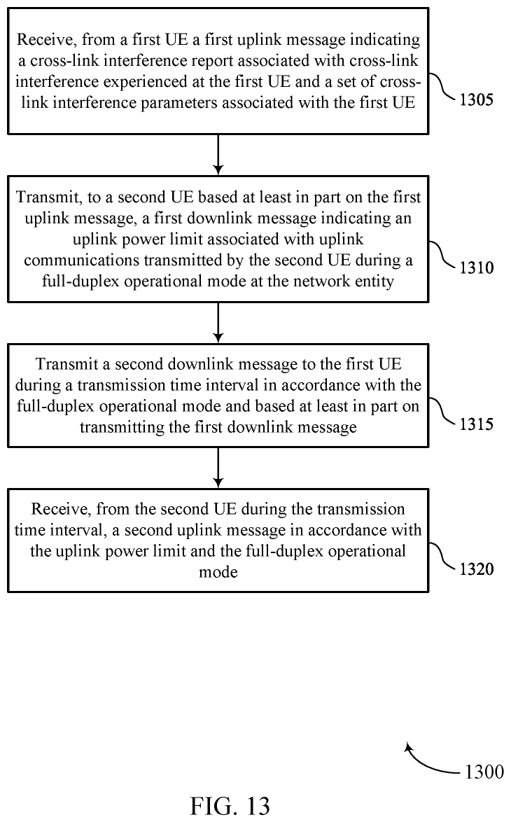

FIG. 13 shows a flowchart illustrating a method 1300 that supports techniques for indicating an uplink power limit for full-duplex communications in accordance with one or more aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include receiving, from a first UE a first uplink message indicating a CLI report associated with CLI experienced at the first UE and a set of CLI parameters associated with the first UE. The operations of 1305 may be performed in accordance with examples as disclosed herein. In some examples, aspects of the operations of 1305 may be performed by a CLI report receiving manager 725 as described with reference to FIG. 7.

At 1310, the method may include transmitting, to a second UE based at least in part on the first uplink message, a first downlink message indicating an uplink power limit associated with uplink communications transmitted by the second UE during a full-duplex operational mode at the network entity. The operations of 1310 may be performed in accordance with examples as disclosed herein. In some examples, aspects of the operations of 1310 may be performed by an uplink power limit transmitting manager 730 as described with reference to FIG. 7.

At 1315, the method may include transmitting a second downlink message to the first UE during a TTI in accordance with the full-duplex operational mode and based at least in part on transmitting the first downlink message. The operations of 1315 may be performed in accordance with examples as disclosed herein. In some examples, aspects of the operations of 1315 may be performed by a downlink message transmitting manager 735 as described with reference to FIG. 7.

At 1320, the method may include receiving, from the second UE during the TTI, a second uplink message in accordance with the uplink power limit and the full-duplex operational mode. The operations of 1320 may be performed in accordance with examples as disclosed herein. In some examples, aspects of the operations of 1320 may be performed by an uplink message receiving manager 740 as described with reference to FIG. 7.

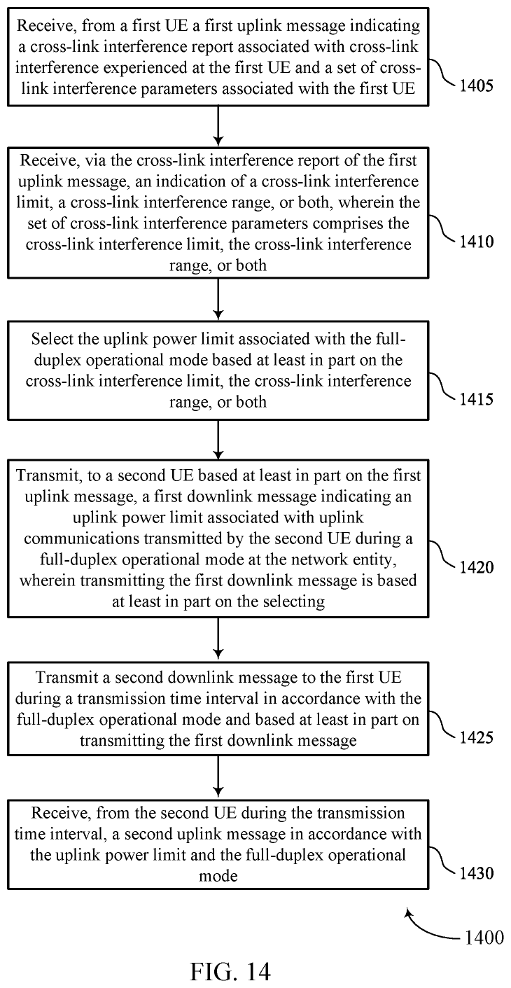

FIG. 14 shows a flowchart illustrating a method 1400 that supports techniques for indicating an uplink power limit for full-duplex communications in accordance with one or more aspects of the present disclosure. The operations of the method 1400 may be implemented by a network entity or its components as described herein. For example, the operations of the method 1400 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1405, the method may include receiving, from a first UE a first uplink message indicating a CLI report associated with CLI experienced at the first UE and a set of CLI parameters associated with the first UE. The operations of 1405 may be performed in accordance with examples as disclosed herein. In some examples, aspects of the operations of 1405 may be performed by a CLI report receiving manager 725 as described with reference to FIG. 7.

At 1410, the method may include receiving, via the CLI report of the first uplink message, an indication of a CLI limit, a CLI range, or both, where the set of CLI parameters includes the CLI limit, the CLI range, or both. The operations of 1410 may be performed in accordance with examples as disclosed herein. In some examples, aspects of the operations of 1410 may be performed by a CLI report receiving manager 725 as described with reference to FIG. 7.

At 1415, the method may include selecting the uplink power limit associated with the full-duplex operational mode based at least in part on the CLI limit, the CLI range, or both. The operations of 1415 may be performed in accordance with examples as disclosed herein. In some examples, aspects of the operations of 1415 may be performed by an uplink power limit selecting manager 745 as described with reference to FIG. 7.

At 1420, the method may include transmitting, to a second UE based at least in part on the first uplink message, a first downlink message indicating an uplink power limit associated with uplink communications transmitted by the second UE during a full-duplex operational mode at the network entity, where transmitting the first downlink message is based at least in part on the selecting. The operations of 1420 may be performed in accordance with examples as disclosed herein. In some examples, aspects of the operations of 1420 may be performed by an uplink power limit transmitting manager 730 as described with reference to FIG. 7.

At 1425, the method may include transmitting a second downlink message to the first UE during a TTI in accordance with the full-duplex operational mode and based at least in part on transmitting the first downlink message. The operations of 1425 may be performed in accordance with examples as disclosed herein. In some examples, aspects of the operations of 1425 may be performed by a downlink message transmitting manager 735 as described with reference to FIG. 7.

At 1430, the method may include receiving, from the second UE during the TTI, a second uplink message in accordance with the uplink power limit and the full-duplex operational mode. The operations of 1430 may be performed in accordance with examples as disclosed herein. In some examples, aspects of the operations of 1430 may be performed by an uplink message receiving manager 740 as described with reference to FIG. 7.

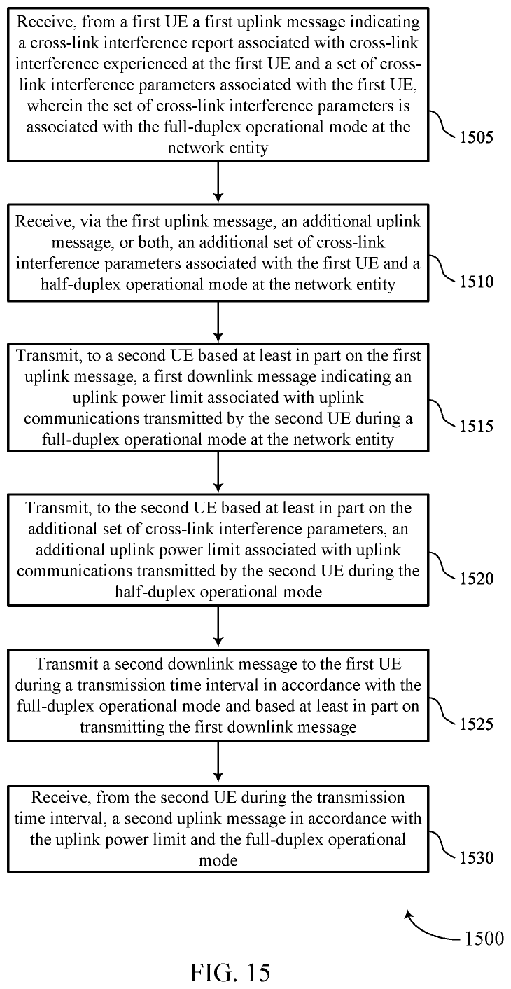

FIG. 15 shows a flowchart illustrating a method 1500 that supports techniques for indicating an uplink power limit for full-duplex communications in accordance with one or more aspects of the present disclosure. The operations of the method 1500 may be implemented by a network entity or its components as described herein. For example, the operations of the method 1500 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a first UE a first uplink message indicating a CLI report associated with CLI experienced at the first UE and a set of CLI parameters associated with the first UE, where the set of CLI parameters is associated with the full-duplex operational mode at the network entity. The operations of 1505 may be performed in accordance with examples as disclosed herein. In some examples, aspects of the operations of 1505 may be performed by a CLI report receiving manager 725 as described with reference to FIG. 7.

At 1510, the method may include receiving, via the first uplink message, an additional uplink message, or both, an additional set of CLI parameters associated with the first UE and a half-duplex operational mode at the network entity. The operations of 1510 may be performed in accordance with examples as disclosed herein. In some examples, aspects of the operations of 1510 may be performed by a CLI report receiving manager 725 as described with reference to FIG. 7.

At 1515, the method may include transmitting, to a second UE based at least in part on the first uplink message, a first downlink message indicating an uplink power limit associated with uplink communications transmitted by the second UE during a full-duplex operational mode at the network entity. The operations of 1515 may be performed in accordance with examples as disclosed herein. In some examples, aspects of the operations of 1515 may be performed by an uplink power limit transmitting manager 730 as described with reference to FIG. 7.

At 1520, the method may include transmitting, to the second UE based at least in part on the additional set of CLI parameters, an additional uplink power limit associated with uplink communications transmitted by the second UE during the half-duplex operational mode. The operations of 1520 may be performed in accordance with examples as disclosed herein. In some examples, aspects of the operations of 1520 may be performed by an uplink power limit transmitting manager 730 as described with reference to FIG. 7.

At 1525, the method may include transmitting a second downlink message to the first UE during a TTI in accordance with the full-duplex operational mode and based at least in part on transmitting the first downlink message. The operations of 1525 may be performed in accordance with examples as disclosed herein. In some examples, aspects of the operations of 1525 may be performed by a downlink message transmitting manager 735 as described with reference to FIG. 7.

At 1530, the method may include receiving, from the second UE during the TTI, a second uplink message in accordance with the uplink power limit and the full-duplex operational mode. The operations of 1530 may be performed in accordance with examples as disclosed herein. In some examples, aspects of the operations of 1530 may be performed by an uplink message receiving manager 740 as described with reference to FIG. 7.

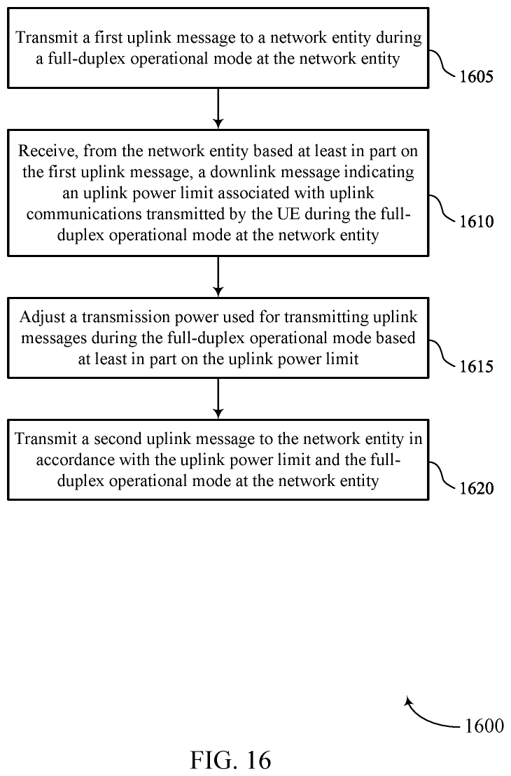

FIG. 16 shows a flowchart illustrating a method 1600 that supports techniques for indicating an uplink power limit for full-duplex communications in accordance with one or more aspects of the present disclosure. The operations of the method 1600 may be implemented by a UE or its components as described herein. For example, the operations of the method 1600 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1605, the method may include transmitting a first uplink message to a network entity during a full-duplex operational mode at the network entity. The operations of 1605 may be performed in accordance with examples as disclosed herein. In some examples, aspects of the operations of 1605 may be performed by an uplink message transmitting manager 1125 as described with reference to FIG. 11.

At 1610, the method may include receiving, from the network entity based at least in part on the first uplink message, a downlink message indicating an uplink power limit associated with uplink communications transmitted by the UE during the full-duplex operational mode at the network entity. The operations of 1610 may be performed in accordance with examples as disclosed herein. In some examples, aspects of the operations of 1610 may be performed by an uplink power limit receiving manager 1130 as described with reference to FIG. 11.

At 1615, the method may include adjusting a transmission power used for transmitting uplink messages during the full-duplex operational mode based at least in part on the uplink power limit. The operations of 1615 may be performed in accordance with examples as disclosed herein. In some examples, aspects of the operations of 1615 may be performed by a transmission power manager 1135 as described with reference to FIG. 11.

At 1620, the method may include transmitting a second uplink message to the network entity in accordance with the uplink power limit and the full-duplex operational mode at the network entity. The operations of 1620 may be performed in accordance with examples as disclosed herein. In some examples, aspects of the operations of 1620 may be performed by an uplink message transmitting manager 1125 as described with reference to FIG. 11.

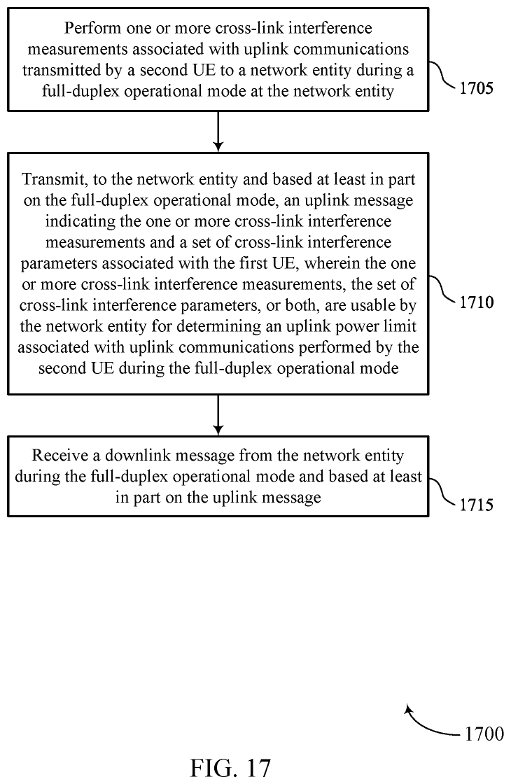

FIG. 17 shows a flowchart illustrating a method 1700 that supports techniques for indicating an uplink power limit for full-duplex communications in accordance with one or more aspects of the present disclosure. The operations of the method 1700 may be implemented by a UE or its components as described herein. For example, the operations of the method 1700 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1705, the method may include performing one or more CLI measurements associated with uplink communications transmitted by a second UE to a network entity during a full-duplex operational mode at the network entity. The operations of 1705 may be performed in accordance with examples as disclosed herein. In some examples, aspects of the operations of 1705 may be performed by a CLI measurement manager 1140 as described with reference to FIG. 11.

At 1710, the method may include transmitting, to the network entity and based at least in part on the full-duplex operational mode, an uplink message indicating the one or more CLI measurements and a set of CLI parameters associated with the first UE, where the one or more CLI measurements, the set of CLI parameters, or both, are usable by the network entity for determining an uplink power limit associated with uplink communications performed by the second UE during the full-duplex operational mode. The operations of 1710 may be performed in accordance with examples as disclosed herein. In some examples, aspects of the operations of 1710 may be performed by a CLI report transmitting manager 1145 as described with reference to FIG. 11.

At 1715, the method may include receiving a downlink message from the network entity during the full-duplex operational mode and based at least in part on the uplink message. The operations of 1715 may be performed in accordance with examples as disclosed herein. In some examples, aspects of the operations of 1715 may be performed by a downlink message receiving manager 1150 as described with reference to FIG. 11.

The following provides an overview of aspects of the present disclosure:

Aspect 1: A method for wireless communication at a network entity, comprising: receiving, from a first UE a first uplink message indicating a CLI report associated with CLI experienced at the first UE and a set of CLI parameters associated with the first UE; transmitting, to a second UE based at least in part on the first uplink message, a first downlink message indicating an uplink power limit associated with uplink communications transmitted by the second UE during a full-duplex operational mode at the network entity; transmitting a second downlink message to the first UE during a TTI in accordance with the full-duplex operational mode and based at least in part on transmitting the first downlink message; and receiving, from the second UE during the TTI, a second uplink message in accordance with the uplink power limit and the full-duplex operational mode.

Aspect 2: The method of aspect 1, further comprising: receiving, via the CLI report of the first uplink message, an indication of a CLI limit, a CLI range, or both, wherein the set of CLI parameters comprises the CLI limit, the CLI range, or both; and selecting the uplink power limit associated with the full-duplex operational mode based at least in part on the CLI limit, the CLI range, or both, wherein transmitting the first downlink message is based at least in part on the selecting.

Aspect 3: The method of aspect 2, wherein the uplink power limit is selected such that CLI experienced at the first UE that is attributable to uplink communications transmitted by the second UE during the full-duplex operational mode is less than or equal to the CLI limit, an upper bound of the CLI range, or both.

Aspect 4: The method of any of aspects 1 through 3, wherein the set of CLI parameters is associated with the full-duplex operational mode at the network entity, the method further comprising: receiving, via the first uplink message, an additional uplink message, or both, an additional set of CLI parameters associated with the first UE and a half-duplex operational mode at the network entity; and transmitting, to the second UE based at least in part on the additional set of CLI parameters, an additional uplink power limit associated with uplink communications transmitted by the second UE during the half-duplex operational mode.

Aspect 5: The method of any of aspects 1 through 4, wherein the set of CLI parameters is associated with a first set of resources usable during the full-duplex operational mode, the method further comprising: receiving, via the first uplink message, an additional uplink message, or both, an additional set of CLI parameters associated with a second set of resources usable during the full-duplex operational mode at the network entity, wherein the uplink power limit is based at least in part on the set of CLI parameters, the additional set of CLI parameters, or both.

Aspect 6: The method of any of aspects 1 through 5, further comprising: receiving, via the first uplink message, a request for reduced CLI at the first UE during a time duration; and transmitting, via the first downlink message, an indication of the time duration associated with the uplink power limit, wherein the TTI is included within the time duration.

Aspect 7: The method of any of aspects 1 through 6, further comprising: receiving, from the second UE, a second uplink message indicating available uplink power information associated with uplink communications transmitted by the second UE during the full-duplex operational mode, wherein the uplink power limit is based at least in part on the available uplink power information.

Aspect 8: The method of aspect 7, further comprising: receiving, via the second uplink message, an indication of one or more parameters associated with the available uplink power information, the one or more parameters comprising a transmit beam at the second UE, a sub-band, a symbol, a resource pattern, or any combination thereof, wherein the uplink power limit is based at least in part on the one or more parameters.

Aspect 9: The method of any of aspects 1 through 8, wherein the uplink power limit comprises an indication of a PSD, a power backoff value, a maximum absolute power value, or any combination thereof.

Aspect 10: The method of any of aspects 1 through 9, wherein the CLI report comprises one or more CLI measurements performed by the first UE on signals received from the second UE during the full-duplex operational mode, the uplink power limit is based at least in part on the one or more CLI measurements.

Aspect 11: The method of any of aspects 1 through 10, wherein the set of CLI parameters associated with the first UE comprise a CLI reduction value, the uplink power limit is based at least in part on the CLI reduction value.

Aspect 12: The method of any of aspects 1 through 11, wherein the first uplink message comprises an indication of the second UE, transmitting the first downlink message to the second UE is based at least in part on the indication of the second UE.

Aspect 13: The method of any of aspects 1 through 12, wherein the first uplink message comprises a UCI, a MAC-CE message, or both.

Aspect 14: A method for wireless communication at a UE, comprising: transmitting a first uplink message to a network entity during a full-duplex operational mode at the network entity; receiving, from the network entity based at least in part on the first uplink message, a downlink message indicating an uplink power limit associated with uplink communications transmitted by the UE during the full-duplex operational mode at the network entity; adjusting a transmission power used for transmitting uplink messages during the full-duplex operational mode based at least in part on the uplink power limit; and transmitting a second uplink message to the network entity in accordance with the uplink power limit and the full-duplex operational mode at the network entity.

Aspect 15: The method of aspect 14, further comprising: transmitting, to the network entity via the first uplink message, an additional uplink message, or both, an indication of available uplink power information associated with uplink communications transmitted by the UE during the full-duplex operational mode, wherein the uplink power limit is based at least in part on the available uplink power information.

Aspect 16: The method of aspect 15, further comprising: transmitting, via the first uplink message, the additional uplink message, or both, an indication of one or more parameters associated with the available uplink power information, the one or more parameters comprising a transmit beam at the UE, a sub-band, a symbol, a resource pattern, or any combination thereof, wherein the uplink power limit is based at least in part on the one or more parameters.

Aspect 17: The method of any of aspects 14 through 16, further comprising: receiving, via the downlink message, an additional downlink message, or both, an additional uplink power limit associated with uplink communications transmitted by the UE during a half-duplex operational mode of the network entity; and transmitting a third uplink message to the network entity in accordance with the additional uplink power limit and the half-duplex operational mode at the network entity.

Aspect 18: The method of any of aspects 14 through 17, further comprising: receiving, via the downlink message, an indication of a time duration associated with the uplink power limit, wherein adjusting the transmission power, transmitting the second uplink message, or both, are based at least in part on the time duration.

Aspect 19: The method of any of aspects 14 through 18, wherein the uplink power limit comprises an indication of a PSD, a power backoff value, a maximum absolute power value, or any combination thereof.

Aspect 20: A method for wireless communication at a first UE, comprising: performing one or more CLI measurements associated with uplink communications transmitted by a second UE to a network entity during a full-duplex operational mode at the network entity; transmitting, to the network entity and based at least in part on the full-duplex operational mode, an uplink message indicating the one or more CLI measurements and a set of CLI parameters associated with the first UE, wherein the one or more CLI measurements, the set of CLI parameters, or both, are usable by the network entity for determining an uplink power limit associated with uplink communications performed by the second UE during the full-duplex operational mode; and receiving a downlink message from the network entity during the full-duplex operational mode and based at least in part on the uplink message.

Aspect 21: The method of aspect 20, further comprising: transmitting, via the uplink message, an indication of a CLI limit, a CLI range, or both, wherein the set of CLI parameters comprise the CLI limit, the CLI range, or both.

Aspect 22: The method of any of aspects 20 through 21, wherein the set of CLI parameters is associated with the full-duplex operational mode at the network entity, the method further comprising: transmitting, via the uplink message, an additional uplink message, or both, an additional set of CLI parameters associated with the first UE and a half-duplex operational mode at the network entity; and receiving an additional downlink message from the network entity during the half-duplex operational mode and based at least in part on the additional set of CLI parameters.

Aspect 23: The method of any of aspects 20 through 22, wherein the set of CLI parameters is associated with a first set of resources usable during the full-duplex operational mode, the method further comprising: transmitting, via the uplink message, an additional uplink message, or both, an additional set of CLI parameters associated with a second set of resources usable during the full-duplex operational mode at the network entity, wherein the downlink message is based at least in part on the set of CLI parameters, the additional set of CLI parameters, or both.

Aspect 24: The method of any of aspects 20 through 23, further comprising: transmitting, via the uplink message, a request for reduced CLI at the first UE during a time duration, wherein the downlink message is received within the time duration.

Aspect 25: The method of any of aspects 20 through 24, wherein the set of CLI parameters associated with the first UE comprise a CLI reduction value, and receiving the downlink message is based at least in part on the CLI reduction value.

Aspect 26: The method of any of aspects 20 through 25, wherein the uplink message comprises an indication of the second UE, receiving the downlink message is based at least in part on the indication of the second UE.

Aspect 27: The method of any of aspects 20 through 26, wherein the uplink message comprises a UCI message, a MAC-CE message, or both.

Aspect 28: An apparatus for wireless communication at a network entity, comprising at least one processor; memory coupled to the at least one processor; and instructions stored in the memory and executable by the at least one processor to cause the network entity to perform a method of any of aspects 1 through 13.

Aspect 29: An apparatus for wireless communication at a network entity, comprising at least one means for performing a method of any of aspects 1 through 13.

Aspect 30: A non-transitory computer-readable medium storing code for wireless communication at a network entity, the code comprising instructions executable by at least one processor to perform a method of any of aspects 1 through 13.

Aspect 31: An apparatus for wireless communication at a UE, comprising at least one processor; memory coupled to the at least one processor; and instructions stored in the memory and executable by the at least one processor to cause the UE to perform a method of any of aspects 14 through 19.

Aspect 32: An apparatus for wireless communication at a UE, comprising at least one means for performing a method of any of aspects 14 through 19.

Aspect 33: A non-transitory computer-readable medium storing code for wireless communication at a UE, the code comprising instructions executable by at least one processor to perform a method of any of aspects 14 through 19.

Aspect 34: An apparatus for wireless communication at a first UE, comprising at least one processor; memory coupled to the at least one processor; and instructions stored in the memory and executable by the at least one processor to cause the first UE to perform a method of any of aspects 20 through 27.

Aspect 35: An apparatus for wireless communication at a first UE, comprising at least one means for performing a method of any of aspects 20 through 27.

Aspect 36: A non-transitory computer-readable medium storing code for wireless communication at a first UE, the code comprising instructions executable by at least one processor to perform a method of any of aspects 20 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), and ascertaining. Also, “determining” can include receiving (such as receiving information), and accessing (such as accessing data in a memory). Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a network entity, comprising:
at least one processor; and
memory coupled to the at least one processor, the memory storing instructions executable by the at least one processor to cause the network entity to:
receive, from a first user equipment (UE) a first uplink message indicating a cross-link interference report associated with cross-link interference experienced at the first UE and a set of cross-link interference parameters associated with the first UE;
transmit, to a second UE based at least in part on the first uplink message, a first downlink message indicating an uplink power limit associated with uplink communications transmitted by the second UE during a full-duplex operational mode at the network entity;
transmit a second downlink message to the first UE during a transmission time interval in accordance with the full-duplex operational mode and based at least in part on transmitting the first downlink message; and
receive, from the second UE during the transmission time interval, a second uplink message in accordance with the uplink power limit and the full-duplex operational mode.

2. The apparatus of claim 1, wherein the instructions are further executable by the processor to cause the network entity to:
receive, via the cross-link interference report of the first uplink message, an indication of a cross-link interference limit, a cross-link interference range, or both, wherein the set of cross-link interference parameters comprises the cross-link interference limit, the cross-link interference range, or both; and
select the uplink power limit associated with the full-duplex operational mode based at least in part on the cross-link interference limit, the cross-link interference range, or both, wherein transmitting the first downlink message is based at least in part on the selecting.

3. The apparatus of claim 2, wherein the uplink power limit is selected such that cross-link interference experienced at the first UE that is attributable to uplink communications transmitted by the second UE during the full-duplex operational mode is less than or equal to the cross-link interference limit, an upper bound of the cross-link interference range, or both.

4. The apparatus of claim 1, wherein the set of cross-link interference parameters is associated with the full-duplex operational mode at the network entity, and the instructions are further executable by the processor to cause the network entity to:
receive, via the first uplink message, an additional uplink message, or both, an additional set of cross-link interference parameters associated with the first UE and a half-duplex operational mode at the network entity; and
transmit, to the second UE based at least in part on the additional set of cross-link interference parameters, an additional uplink power limit associated with uplink communications transmitted by the second UE during the half-duplex operational mode.

5. The apparatus of claim 1, wherein the set of cross-link interference parameters is associated with a first set of resources usable during the full-duplex operational mode, and the instructions are further executable by the processor to cause the network entity to:
receive, via the first uplink message, an additional uplink message, or both, an additional set of cross-link interference parameters associated with a second set of resources usable during the full-duplex operational mode at the network entity, wherein the uplink power limit is based at least in part on the set of cross-link interference parameters, the additional set of cross-link interference parameters, or both.

6. The apparatus of claim 1, wherein the instructions are further executable by the processor to cause the network entity to:
receive, via the first uplink message, a request for reduced cross-link interference at the first UE during a time duration; and
transmit, via the first downlink message, an indication of the time duration associated with the uplink power limit, wherein the transmission time interval is included within the time duration.

7. The apparatus of claim 1, wherein the instructions are further executable by the processor to cause the network entity to:
receive, from the second UE, a second uplink message indicating available uplink power information associated with uplink communications transmitted by the second UE during the full-duplex operational mode, wherein the uplink power limit is based at least in part on the available uplink power information.

8. The apparatus of claim 7, wherein the instructions are further executable by the processor to cause the network entity to:
receive, via the second uplink message, an indication of one or more parameters associated with the available uplink power information, the one or more parameters comprising a transmit beam at the second UE, a sub-band, a symbol, a resource pattern, or any combination thereof, wherein the uplink power limit is based at least in part on the one or more parameters.

9. The apparatus of claim 1, wherein the uplink power limit comprises an indication of a power spectral density, a power backoff value, a maximum absolute power value, or any combination thereof.

10. The apparatus of claim 1, wherein the cross-link interference report comprises one or more cross-link interference measurements performed by the first UE on signals received from the second UE during the full-duplex operational mode, and wherein the uplink power limit is based at least in part on the one or more cross-link interference measurements.

11. The apparatus of claim 1, wherein the set of cross-link interference parameters associated with the first UE comprise a cross-link interference reduction value, and wherein the uplink power limit is based at least in part on the cross-link interference reduction value.

12. The apparatus of claim 1, wherein the first uplink message comprises an indication of the second UE, and wherein transmitting the first downlink message to the second UE is based at least in part on the indication of the second UE.

13. The apparatus of claim 1, wherein the first uplink message comprises an uplink control information message, a medium access control-control element message, or both.

14. An apparatus for wireless communication at a user equipment (UE), comprising:
at least one processor; and
memory coupled to the at least one processor, the memory storing instructions executable by the at least one processor to cause the UE to:
transmit a first uplink message to a network entity during a full-duplex operational mode at the network entity;
receive, from the network entity based at least in part on the first uplink message, a downlink message indicating an uplink power limit associated with uplink communications transmitted by the UE during the full-duplex operational mode at the network entity;
adjust a transmission power used for transmitting uplink messages during the full-duplex operational mode based at least in part on the uplink power limit; and
transmit a second uplink message to the network entity in accordance with the uplink power limit and the full-duplex operational mode at the network entity.

15. The apparatus of claim 14, wherein the instructions are further executable by the processor to cause the UE to:
transmit, to the network entity via the first uplink message, an additional uplink message, or both, an indication of available uplink power information associated with uplink communications transmitted by the UE during the full-duplex operational mode, wherein the uplink power limit is based at least in part on the available uplink power information.

16. The apparatus of claim 15, wherein the instructions are further executable by the processor to cause the UE to:
transmit, via the first uplink message, the additional uplink message, or both, an indication of one or more parameters associated with the available uplink power information, the one or more parameters comprising a transmit beam at the UE, a sub-band, a symbol, a resource pattern, or any combination thereof, wherein the uplink power limit is based at least in part on the one or more parameters.

17. The apparatus of claim 14, wherein the instructions are further executable by the processor to cause the UE to:
receive, via the downlink message, an additional downlink message, or both, an additional uplink power limit associated with uplink communications transmitted by the UE during a half-duplex operational mode of the network entity; and
transmit a third uplink message to the network entity in accordance with the additional uplink power limit and the half-duplex operational mode at the network entity.

18. The apparatus of claim 14, wherein the instructions are further executable by the processor to cause the UE to:
receive, via the downlink message, an indication of a time duration associated with the uplink power limit, wherein adjusting the transmission power, transmitting the second uplink message, or both, are based at least in part on the time duration.

19. The apparatus of claim 14, wherein the uplink power limit comprises an indication of a power spectral density, a power backoff value, a maximum absolute power value, or any combination thereof.

20. An apparatus for wireless communication at a first user equipment (UE), comprising:
at least one processor; and
memory coupled to the at least one processor, the memory storing instructions executable by the at least one processor to cause the first UE to:
perform one or more cross-link interference measurements associated with uplink communications transmitted by a second UE to a network entity during a full-duplex operational mode at the network entity;
transmit, to the network entity and based at least in part on the full-duplex operational mode, an uplink message indicating the one or more cross-link interference measurements and a set of cross-link interference parameters associated with the first UE, wherein the one or more cross-link interference measurements, the set of cross-link interference parameters, or both, are usable by the network entity for determining an uplink power limit associated with uplink communications performed by the second UE during the full-duplex operational mode; and
receive a downlink message from the network entity during the full-duplex operational mode and based at least in part on the uplink message.

21. The apparatus of claim 20, wherein the instructions are further executable by the processor to cause the first UE to:
transmit, via the uplink message, an indication of a cross-link interference limit, a cross-link interference range, or both, wherein the set of cross-link interference parameters comprise the cross-link interference limit, the cross-link interference range, or both.

22. The apparatus of claim 20, wherein the set of cross-link interference parameters is associated with the full-duplex operational mode at the network entity, and the instructions are further executable by the processor to cause the first UE to:
transmit, via the uplink message, an additional uplink message, or both, an additional set of cross-link interference parameters associated with the first UE and a half-duplex operational mode at the network entity; and
receive an additional downlink message from the network entity during the half-duplex operational mode and based at least in part on the additional set of cross-link interference parameters.

23. The apparatus of claim 20, wherein the set of cross-link interference parameters is associated with a first set of resources usable during the full-duplex operational mode, and the instructions are further executable by the processor to cause the first UE to:
transmit, via the uplink message, an additional uplink message, or both, an additional set of cross-link interference parameters associated with a second set of resources usable during the full-duplex operational mode at the network entity, wherein the downlink message is based at least in part on the set of cross-link interference parameters, the additional set of cross-link interference parameters, or both.

24. The apparatus of claim 20, wherein the instructions are further executable by the processor to cause the first UE to:
transmit, via the uplink message, a request for reduced cross-link interference at the first UE during a time duration, wherein the downlink message is received within the time duration.

25. The apparatus of claim 20, wherein the set of cross-link interference parameters associated with the first UE comprise a cross-link interference reduction value, and wherein receiving the downlink message is based at least in part on the cross-link interference reduction value.

26. The apparatus of claim 20, wherein the uplink message comprises an indication of the second UE, and wherein receiving the downlink message is based at least in part on the indication of the second UE.

27. The apparatus of claim 20, wherein the uplink message comprises an uplink control information message, a medium access control-control element message, or both.

28. A method for wireless communication at a network entity, comprising:
receiving, from a first user equipment (UE) a first uplink message indicating a cross-link interference report associated with cross-link interference experienced at the first UE and a set of cross-link interference parameters associated with the first UE;
transmitting, to a second UE based at least in part on the first uplink message, a first downlink message indicating an uplink power limit associated with uplink communications transmitted by the second UE during a full-duplex operational mode at the network entity;
transmitting a second downlink message to the first UE during a transmission time interval in accordance with the full-duplex operational mode and based at least in part on transmitting the first downlink message; and
receiving, from the second UE during the transmission time interval, a second uplink message in accordance with the uplink power limit and the full-duplex operational mode.

29. The method of claim 28, further comprising:
receiving, via the cross-link interference report of the first uplink message, an indication of a cross-link interference limit, a cross-link interference range, or both, wherein the set of cross-link interference parameters comprises the cross-link interference limit, the cross-link interference range, or both; and
selecting the uplink power limit associated with the full-duplex operational mode based at least in part on the cross-link interference limit, the cross-link interference range, or both, wherein transmitting the first downlink message is based at least in part on the selecting.

30. The method of claim 29, wherein the uplink power limit is selected such that cross-link interference experienced at the first UE that is attributable to uplink communications transmitted by the second UE during the full-duplex operational mode is less than or equal to the cross-link interference limit, an upper bound of the cross-link interference range, or both.
